(19) United States
(12) Patent Application Publication
(10) Pub. No.: US 2018/0197196 A1
(43) Pub. Date: Jul. 12, 2018

(54) SERVICE METHOD FOR PROVIDING CONTENT INFORMATION USING BEACON AND METHOD FOR DETERMINING WHETHER OR NOT USER ENTERS AND LEAVES STORE

(71) Applicant: SK Planet Co., Ltd., Seongnam-si (KR)

(72) Inventors: Eungsup Cho, Yongin-si (KR); Seungwon Na, Seoul (KR); Jongil Kim, Seoul (KR)

(21) Appl. No.: 15/914,867

(22) Filed: Mar. 7, 2018

Related U.S. Application Data
(63) Continuation of application No. PCT/KR2016/007317, filed on Jul. 6, 2016.

(30) Foreign Application Priority Data
Sep. 7, 2015 (KR) 10-2015-0126021
Oct. 8, 2015 (KR) 10-2015-0141396
Oct. 30, 2015 (KR) 10-2015-0151900

(51) Int. Cl. G06Q 30/02; H04W 4/021; H04W 4/80

(52) U.S. Cl. CPC G06Q 30/0238; H04W 4/80; H04W 4/021; G06Q 30/0224

(57) ABSTRACT

A terminal device that includes: a receiving unit configured to receive beacon device unique information and location information from location information providing devices installed in respective one of at least one locations; a managing unit configured to manage a list of locations according to the beacon device unique information and the location information; a processing unit configured to determine a final location list including candidate locations that have been given high priorities by the managing unit by taking into account the location information; and a transmission unit configured to request a location management server for a digital content service related to the final location list is disclosed.

### CROSS-REFERENCE TO RELATED APPLICATIONS

This application is a continuation of and claims priority to PCT Application No. PCT/KR2016/007317, filed on Jul. 6, 2016, which claims priority to Korean Patent Application No. 10-2015-0126021, filed on Sep. 7, 2015, Korean Patent Application No. 10-2015-0141396, filed on Oct. 8, 2015, and Korean Patent Application No. 10-2015-0151900, filed on Oct. 30, 2015, the entire contents of which are incorporated by reference.

### BACKGROUND

This specification relates to providing content information and determining user location. Conventional technology utilizing proximity sensors and a smart phone of a user to notify the user of a user status at a particular geographic region and, based on the geographic region, transmit particular information to the terminal of the user is becoming more popular at an early stage.

### SUMMARY

Proximity sensors typically are beacon devices that are configured to send a wireless signal such as a Wi-Fi signal, a Bluetooth Low Energy (BLE) signal, a sound signal, and a Near Field Communication (NFC) signal. Apple Inc. recently launched a beacon service called ‘iBeacon’ that uses BLE beacon devices, and is providing an application program through the Apple Store in the United States.

When a customer who is using this service enters a shop, the customer may check product information and customer ratings automatically and receive discount coupons.

In the system providing the iBeacon service, the user terminal (e.g. a mobile device such as a smart phone) may receive a radio wave broadcasted by BLE beacon devices in respective shops or a predetermined location and receive digital contents such as a coupon that may be used in a corresponding shop.

Referring to FIG. 1, a terminal receives a signal transmitted by a beacon device installed in a shop C (step 1), and sends the received information to a customer database (step 2).

A shop management server checks a subscription status of a customer who may be an existing customer or a new customer that wants a digital coupon on the basis of log-in information received from the terminal, and transmits the digital coupon (e.g., product information or discount coupon) to the terminal. This is a typical service scheme currently being used.

If the beacons installed in shops A through F do not interfere with each other, the service may be provided smoothly.

In a data density area, however, radio reception errors due to interferences between radio waves transmitted by a plurality of beacon devices in respective shops may cause the digital contents not to be properly transferred to the user terminal. Further, lots of digital contents may be received by the user terminal at a time, which may make the terminal device to treat the digital contents as spam or cause a collision between received information during the processing of the digital contents.

On the other hand, methods for estimating the location of the terminal device having received the beacon signal transmitted by the beacon device installed in the shop by use of the beacon signal and utilizing estimated location information are being studied nowadays.

Further, a specific service may be provided to the terminal device that has entered a shop by using the location information or user information such as purchasing propensity or an area of interest of the user may be extracted by using information of the shop that the terminal device has entered to utilize in the marketing.

The method estimates the location of the terminal device by using only the beacon signal transmitted by the beacon device, and then determines the entry of the terminal device into the shop based on the estimated location information. However, the method of estimating the location by the beacon signal is error-prone and cannot accurately predict the entry/exit of the terminal device at the shop.

The present disclosure relates to a method of providing contents providing service and a method of determining entry or exit in a shop utilizing beacon. More particularly, the present disclosure relates to a method and apparatus for providing digital contents such as a digital coupon to a terminal device of a user by use of strength of and information in radio waves transmitted by a beacon device and determining the entry/exit of the terminal device in the shop by utilizing behavior pattern of the user holding the terminal device.

According to a first implementation of the present disclosure, provided are a system and a method of effectively processing sensor information received from a plurality of beacon devices installed at respective one of a plurality of shops or a shop complex that may not be compartmentalized.

According to a second and a third implementations of the present disclosure, provided are a method and apparatus for accurately determining entry/exit of a terminal device at a shop by estimating a distance between a beacon device transmitting a beacon signal and the terminal receiving the beacon signal based on a received signal strength, calculating a stay time based on a signal receipt time, extracting behavior pattern of a user based on sensing information collected by one or more sensors, and comparing an estimated distance, a calculated stay time, and extracted behavior pattern with preset shop range information, a threshold for stay time information, and preset behavior pattern information, respectively, to determine the entry/exit of the terminal device.

It is to be understood that the technical problems to be solved by the present disclosure are not limited to the above-mentioned problems and other technical problems having not mentioned above will be apparent to those skilled in the art from the following description.

According to an aspect of exemplary implementations, a terminal device includes: a receiving unit configured to receive beacon device unique information and shop information from shop information providing devices installed in respective one of at least one shops; a managing unit configured to manage a list of shops according to the beacon device unique information and the shop information; a processing unit configured to determine a final shop list including candidate shops that have been given high priorities by the managing unit by taking into account the shop information; and a transmission unit configured to request a shop management server for a digital content service related to the final shop list.

The terminal device may further include a priority determination module configured to sort the list of shops according to the priorities of the shops. The priority determination module may include: a signal strength measurement unit configured to measure signal strength of a received signal transmitted by the shop information providing devices; an administrator preference determination unit configured to determine preference of an administrator providing the digital content service; a customer purpose determination unit configured to determine a purpose of using a good or a service of a user of the terminal device receiving the digital contents service; and a sorting unit configured to sort the list of shops based on priority comparison basis information provided by the signal strength measurement unit, the administrator preference determination unit, and the customer purpose determination unit. The administrator preference determination unit determines the administrator preference based on at least one information of: a number of times that the user has used the digital content service provided by the administrator, whether or not the user agreed to provide location information, a location of the terminal device identified by provided location information, an age or sex of the user, and whether or not the user subscribed to an application associated with the digital content service.

The customer purpose determination unit may determine the purpose of the user by using at least one of: preference of the user for the good or the service, a price range of the good or the service, and a product type. The sorting unit may sort the list of shops after applying weighting factors to each of the priority comparison basis information. The sorting unit may choose at least one kind of basis information among the priority comparison basis information provided by the signal strength measurement unit, the administrator preference determination unit, and the customer purpose determination unit, and sort the list of shops based on chosen basis information only.

The shop information of the candidate shops having been given the high priorities by the managing unit may include at least one of: a business type of the shop, a size of the shop, a number of products in the shop, a number of employees, a number of daily visiting customers, and a number of customers currently in the shop. The processing unit may determine the candidate shops to be included in the final shop list based on the shop information as well as information whether the user is staying in the shop or has moved to another shop.

According to another aspect of exemplary implementations, provided is a method of providing contents information service using beacon device priority by a terminal device. The method includes operations of: (a) receiving beacon device unique information and shop information from shop information providing devices installed in respective one of at least one shops; (b) managing a list of shops according to the beacon device unique information and the shop information; (c) determining a final shop list including candidate shops that have been given high priorities by the managing unit by taking into account the shop information; and (d) requesting a shop management server for a digital content service related to the final shop list.

According to yet another aspect of exemplary implementations, a terminal device includes: a first communication module configured to receive a beacon signal periodically transmitted by a beacon device; and a control module configured to calculate a distance to the beacon device based on a received signal strength of the beacon signal, and determines that the terminal device entered a shop in which the beacon device is installed when a calculated distance is smaller than a threshold for shop range information corresponding to the shop.

The control module may further calculate a stay time based on a receipt time of the beacon signal, and determine that the terminal device entered the shop when a calculated stay time is greater than a threshold for shop stay time information corresponding to the shop. The control module may preliminarily determine that the terminal device entered the shop if the calculated distance is smaller than the threshold for the shop range information, and finally determine that the terminal device entered the shop if the calculated stay time is greater than the threshold for the shop stay time information. The control module may determine that the terminal device exited the shop when the calculated distance acquired after the terminal device is determined to have entered the shop is getting larger than the threshold for the shop range information corresponding to the shop.

The control module may control the terminal device to receive a service content of the shop corresponding to the calculated stay time from a shop management server and to expose the service content through an output module when the terminal device is determined to have entered the shop. The terminal device may further include a second communication module configured to transmit and receive data to and from a shop management server through a communications network. The control module may receive the shop range information and the shop stay time information through the second communication module. The terminal device may further include a sensor module including at least one sensor configured to output sensing information representing a physical change in the vicinity of the terminal device. The control module may recognize user's situation based on the sensing information, extract behavior pattern of the user based on recognized situation information, and determine that the terminal device entered the shop when extracted behavior pattern matches preset behavior pattern information.

The control module may preliminarily determine that the terminal device entered the shop if the calculated distance is smaller than the threshold for the shop range information, and finally determine that the terminal device entered the shop if the extracted behavior pattern matches the preset behavior pattern information. The control module may calculate a stay time based on a receipt time of the beacon signal when the extracted behavior pattern matches the preset behavior pattern information, and finally determine that the terminal device entered the shop when the calculated stay time is greater than the threshold for the shop stay time information. The behavior pattern information may be set separately for each shop in which the beacon device is installed based on information of the shop.

The terminal device may further include a second communication module configured to transmit and receive data to and from a shop management server through a communications network. The control module may receive the shop range information and the behavior pattern information through the second communication module.

According to yet another aspect of exemplary implementations, a shop management server includes: a communication module configured to transmit and receive data to and from a terminal device through a communications network; a storage module configured to store shop range information of a shop corresponding to a beacon device; and a control module configured to calculate a distance between the terminal device and the beacon device based on a received signal strength of a beacon signal when the received signal strength is received from the terminal device that have received the beacon signal through the communication module, and determines that the terminal device entered the shop when a calculated distance is smaller than a threshold for the shop range information.

The storage module may further store stay time information of the shop corresponding to the beacon device. The control module may further calculate a stay time based on a receipt time of the beacon signal when receipt time of the beacon signal is received from the terminal device that have received the beacon signal through the communication module, and determine that the terminal device entered the shop when a calculated stay time is greater than a threshold for the stay time information. The control module may preliminarily determine that the terminal device entered the shop if the calculated distance is smaller than the threshold for the shop range information, and finally determine that the terminal device entered the shop if the calculated stay time is greater than the threshold for the shop stay time information. The control module may determine that the terminal device exited the shop when the calculated distance acquired after the terminal device is determined to have entered the shop is getting larger than the threshold for the shop range information corresponding to the shop.

The control module controls the shop management server to transmit a service content of the shop corresponding to the calculated stay time to the terminal device when the terminal device is determined to have entered the shop. The storage module may further store behavior pattern information of the shop corresponding to the beacon device. The control module may extract a behavior pattern based on at least one sensing information collected by the terminal device, and determine that the terminal device entered the shop when the extracted behavior pattern matches the behavior pattern information stored in the storage unit. The control module may preliminarily determine that the terminal device entered the shop if the calculated distance is smaller than the threshold for the shop range information, and finally determine that the terminal device entered the shop if the extracted behavior pattern matches the behavior pattern information stored in the storage unit.

The behavior pattern information may be set separately for each shop in which the beacon device is installed based on information of the shop.

According to yet another aspect of exemplary implementations, provided is a method of determining shop entry/exit based on a beacon signal transmitted from a beacon device installed in a shop. The method includes operations of: checking a received signal strength of the beacon signal received by a terminal device located closely to the shop; calculating a distance between the beacon device and the terminal device based on the received signal strength; comparing a calculated distance with a threshold for shop range information; and determining the terminal device entered the shop if the calculated distance is smaller than the threshold for the shop range information.

In the checking operation, a receipt time of the beacon signal may be further checked. In the calculating operation, a stay time may be further calculated based on the receipt time. In the comparing operation, the calculated stay time may be compared with a threshold for shop stay time information. In the determining operation, the terminal device may be determined to have entered the shop if the stay time is greater than the threshold for the shop stay time information. The method may further include an operation of: extracting behavior pattern based on at least one sensing information collected by the terminal device. In the comparing operation, an extracted behavior pattern may be compared with preset behavior pattern information. In the determining operation, the terminal device may be determined to have entered the shop if the extracted behavior pattern matches the preset behavior pattern information.

The subject matter described in this specification can be implemented in particular embodiments so as to realize one or more of the following advantages. According to the present disclosure, sensor information received from a plurality of beacon devices installed in respective one of a plurality of shops or a shop complex not being compartmentalized may be processed effectively by utilizing the received signal strength information, and a possibility that the digital contents are treated as spam may be reduced.

Also, since one of the shops is selected in consideration of the administrator's preference and the customer's purpose of using the product in addition to the received signal strength, and services associated with a selected shop is provided to the terminal device, contents customized to the administrator or the customer may be provided to the user.

When the terminal device receives the beacon signal from the beacon device, the distance from the beacon device transmitting the beacon signal is estimated based on the received signal strength, the stay time is calculated based on the signal receipt time, the user's situation is recognized based on sensing information measured by one or more sensors, the behavior pattern of the user is extracted based on the recognized situation, and then the shop entry/exit is determined based on the estimated distance, the calculated stay time, and the extracted behavior pattern. Accordingly, the entry/exit of the terminal device at a shop may be determined accurately.

When the calculated stay time of a customer is long at a shop, the customer is expected to have high purchase intension at the shop, and service contents corresponding to the stay time is provided to the terminal device of the customer. Thus, the shop may enhance a buying rate of the customer at the shop, and the customer may achieve reasonable consumption.

Various advantageous effects other than those described above may be disclosed explicitly or implicitly in the following descriptions of implementations according to the present disclosure.

### BRIEF DESCRIPTION OF THE DRAWINGS

FIG. 1 is a schematic view illustrating an example process of providing shop information service.

FIG. 2 is a block diagram schematically illustrating an example system for providing contents information and entry/exit determining service according to an implementation of the present disclosure.

FIG. 3 is a block diagram of an example shop information providing device in a contents information providing system using beacon device propagation priority according to a first implementation of the present disclosure.

FIG. 4 is a flowchart illustrating an example method of providing shop information and beacon identification information performed by the shop information providing device according to the first implementation of the present disclosure.

FIG. 5 is a block diagram of an example terminal device.

FIG. 6 is a block diagram of an example priority determination module of the terminal device according to the first implementation of the present disclosure.

FIG. 7 is a flowchart illustrating an example method of providing contents information service using beacon device propagation priority according to the first implementation of the present disclosure.

FIG. 8 is a flowchart illustrating an example method of sorting a shop list based on priorities assigned to shops performed by the terminal device according to the first implementation of the present disclosure.

FIGS. 9 through 12 are flowcharts illustrating example operations of the terminal device according to a second and third implementations of the present disclosure.

FIG. 13 is a block diagram of an example shop management server.

FIGS. 14 and 15 are flowcharts illustrating example operations of the shop management server according to the second and third implementations of the present disclosure.

FIG. 16 is a flowchart illustrating an example method of providing the shop information and the beacon identification information performed by the shop information providing device according to the first implementation of the present disclosure.

FIGS. 17 and 18 are flowcharts illustrating example methods of determining shop entry/exit according to implementations of the present disclosure.

FIG. 19 is a schematic view illustrating an example method of providing contents information service utilizing the contents information providing system that uses the beacon device propagation priority according to the first implementation of the present disclosure.

FIG. 20 is a flowchart of an example method of determining shop entry/exit according to a second and a third implementations of the present disclosure.

FIG. 21 is a block diagram illustrating an example operation environment of a system for determining shop entry/exit according to an implementation of the present disclosure.

### DETAILED DESCRIPTION

For a more clear understanding of the features and advantages of the present disclosure, the present disclosure will be described in detail with reference to the accompanied drawings.

In the following description and the accompanied drawings, detailed descriptions of well-known functions or configuration that may obscure the subject matter of the present disclosure will be omitted for simplicity. It is to be noted that the same components are designated by the same reference numerals throughout the drawings.

The terms and words used in the following description and drawings are not necessarily to be construed in an ordinary sense or a dictionary, and may be appropriately defined herein to be used as terms for describing the present disclosure in the best way possible. Such terms and words should be construed as meaning and concept consistent with the technical idea of the present disclosure. The configurations of implementations described in this specification or shown in the drawings are merely the most preferred implementations of the present disclosure, and do not limit the technical ideas of the present disclosure. Therefore, it should be understood that there are various equivalents and modifications that may replace the configurations of the implementations.

The terminologies including ordinals such as “first” and “second” used to explain various elements in this specification may be used to discriminate an element from the other ones or for simplicity. For example, a second component may be referred to as a first component, and similarly, a first component may also be referred to as a second component without departing from the scope of the present disclosure.

The terminology used herein is for the purpose of describing particular implementations only and is not intended to be limiting of the disclosure. The singular forms include plural referents unless the context clearly dictates otherwise. Also, The expressions “˜comprises,” “˜includes,” “˜constructed,” “˜configured” are not to be construed as being equipped with all the components, processing steps, or operations described in this specification, but some of the components, the processing steps, or the operations may not be included and additional elements may be incorporated further.

Terminologies such as “˜unit” and “˜module” refer to entities performing at least one function or operation, and may be implemented by hardware, software, or combination thereof. The articles ‘a,’ ‘an,’ ‘the,’ ‘one,’ and their equivalents may be used in the sense of including both the singular and the plural meaning unless the context clearly indicates otherwise or is clearly contradicted by context in the context of describing the disclosure, particularly, in the context of the following claims.

Other terminologies are used herein for the purpose of facilitating understanding of the present disclosure, and the use of such specific terminologies may be changed into other forms without departing from the spirit of the present disclosure.

The implementations within the scope of the present disclosure include computer-readable media having or carrying computer executable instructions or data structures stored in computer-readable media. Such computer-readable media may be an arbitrary media that is accessible by a general purpose or special purpose computer system. The computer-readable media may include, but is not limited to, a physical storage media such as RAM, ROM, EPROM, CD-ROM, other optical disk storage, a magnetic disk storage, and other magnetic storage devices. The computer-readable media may be used to store or deliver certain program code means in the form of computer-executable instructions, computer-readable instructions, or data structures.

The present disclosure may be practiced in a networked computing environment including at least one of various types of computing systems such as a personal computer, a laptop computer, a handheld device, a multiprocessor system, a microprocessor-based or programmable consumer electronics, a network PC, a minicomputer, a mainframe computer, a pager, and so on. Also, the present disclosure may be practiced in distributed system environment where both a local and a remote computer systems linked by wired data links, wireless data links, or a combination of wired and wireless data links over a network perform tasks. In a distributed system environment, the program modules may reside in local and remote storage devices.

The service of determining entry/exit of the terminal device in a shop (hereinbelow, referred to as ‘shop entry/exit’) will be described in terms of Bluetooth low energy (BLE) data communication technology.

While the NFC is operable only when the devices are located within a few tens of centimeters, the Bluetooth system is operable even when the devices are spaced apart by a distance of several tens of meters, and thus application thereof is getting wider and wider. In particular, The Bluetooth allows data transfer between the devices without tagging or bringing a device closer to another device such as a reader unlike the NFC. Further, the Bluetooth enables to transfer customized data even when the devices are moving in a building.

Nevertheless, however, the present disclosure does not require the Bluetooth or Bluetooth Low Energy (BLE) as a prerequisite, and other local communications schemes of Personal Area Network (PAN) technology such as Zigbee, Ultra-WideBand (UWB), ANT, and Wi-Fi may be applicable.

Now, a method and system for providing contents information and determining shop entry/exit according to implementations of the present disclosure will be described in detail.

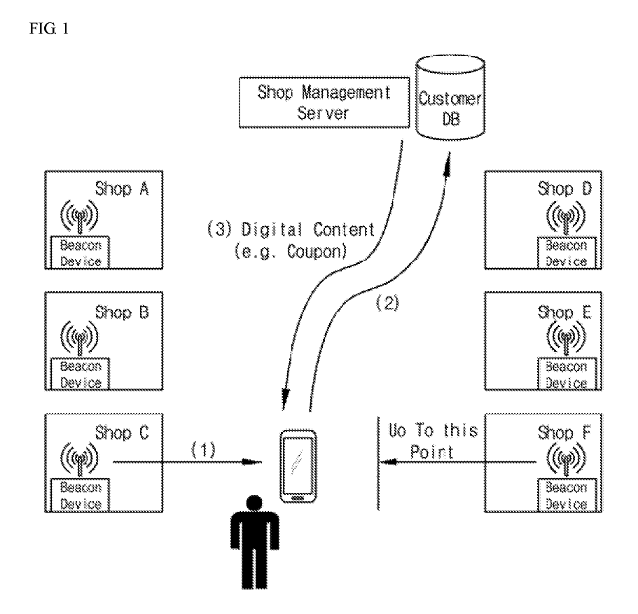

FIG. 1 is a schematic view illustrating a process of providing shop information service.

In this system, service progress is achieved stably unless there is interference between beacon devices installed in the shops A through F. For example, when a terminal user receives digital contents for a shop C from a contents information providing server, another shop F cannot provide the same service as the shop C because the shop F is spaced apart from the terminal.

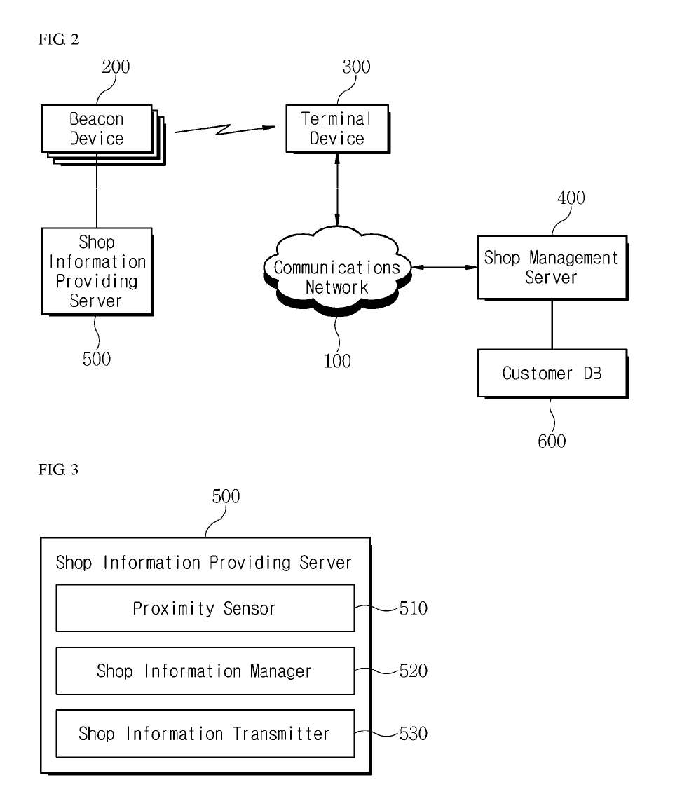

FIG. 2 is a block diagram schematically illustrating a system for providing contents and entry/exit determining service according to an implementation of the present disclosure.

Referring to FIG. 2, the system for entry/exit determining service according to an implementation of the present disclosure includes a beacon device 200, a terminal device 300, a shop management server 400, a shop information providing device 500, and a customer database 600.

Here, the terminal device 300 transmits and receives data through Bluetooth Low Energy (BLE) communications with the beacon device 200. However, the communication scheme is not limited thereto, and any of Personal Area network (PAN) communications scheme may be applied to communications between the devices.

The terminal device 300 is interfaced to the shop management server 400 through a communications network 100.

Each element shown in FIG. 2 will now be described briefly.

First, the communication network 100 transfers data to enable data exchange between the terminal device 300 and the shop management server 400. Depending on the system implementation, the communication network 100 may include a wired communications network, e.g., an Ethernet, a Digital Subscriber Line (xDSL) network such as a Asymmetric Digital Subscriber Line (ADSL) network and a Very High Bitrate Digital Subscriber Line (VDSL) network, a Hybrid Fiber Coaxial Cable (HFC) network, a Fiber-to-the-Curb (FTTC) network, and a fiber-to-the-home (FTTH) network. Alternatively, the communication network 100 may include a wireless communications network such as Wireless Local Area Network (WLAN), a Wi-Fi network, a wireless broadband Internet (Wibro), a Worldwide Interoperability for Microwave Access (WiMAX) network, a High Speed Downlink Packet Access (HSDPA) network, a Long Term Evolution (LTE) network, a Long Term Evolution Advanced (LTE-A) network.

Also, the communications network 100 includes a plurality of access networks (not shown) and a core network (not shown), and may further include an external network such as Internet (not shown). The access network (not shown) which performs communications with the terminal device 300 includes a plurality of base stations such as a traditional base station (BS), a base transceiver station (BTS), a Node B (or NodeB), an Evolved Node B (eNodeB), and a plurality of base stations such as a traditional Base Station Controller (BSC) or a Radio Network Controller (RNC). Meanwhile, a digital signal processing unit and a radio signal processing unit integrally implemented in the base station may be divided into a digital unit (as DU) and a radio unit (RU), so that each of a plurality of RUs are provided in respective one of a plurality of areas, and the plurality of RUs) are connected to a centralized DU.

A core network constituting a mobile network together with the access network connects the access network to an external network, for example, the Internet.

The core network, which performs main functions for mobile communication services such as mobility control and switching among the access networks, performs circuit switching or packet switching operations and manages and controls packet flow in the communications network 100. Also, the core network allows inter-frequency mobility and may play a role for interworking traffics in the access network and the core network with another network such as the Internet. The core network may further include at least one of: a Serving Gateway (SGW), a Packet Data Network (PDN) Gateway, a Mobile Switching Center (MSC), a Home Location Register (HLR), a Mobile Management (MME), and a Home Subscriber Server (HSS).

The Internet, which refers to a public network that allows information exchange according to a TCP/IP protocol, is connected to the terminal device 300 and may provide information provided by the terminal device 300 to the shop management server 400 via the core network and the access network while providing information provided by the shop management server 400 to the terminal device 300 via the core network and the access network. However, the present disclosure is not limited thereto, and the shop management server 400 may be incorporated with the core network.

Besides, the communications network 100 may include other types of communication schemes already known in the art or to be developed in the future.

The beacon device 200 refers to a device that periodically transmits a beacon signal for a beacon service. Here, beacon identification information such as identification information assigned to the beacon device 200 or location information of the beacon device 200 may be included in the beacon signal. The beacon identification information may be used as a reference that the terminal device 300 receives the beacon service.

The terminal device 300 in the present disclosure refers to a user equipment capable of transmitting and receiving various data through the communications network 100 according to an operation of the user. The terminal device 300, which may perform voice or data communications through the communications network 100, may exchange information with the shop management server 400 through the communications network 100 and receive information from the beacon device 200 through beacon-based communications. The terminal device 300 may include a memory for storing programs and protocols for transmitting, receiving, and processing beacon signals and a microprocessor for executing various programs for calculation and control purposes.

The terminal device 300 may first access an application providing apparatus, e.g. an application store server, connected to the communications network 100 to receive and install a beacon service application that receives the beacon signal and displays contents corresponding to the beacon signal. The terminal device 300 executes the beacon service application to extract the beacon identification information from the beacon signal, transmit the beacon identification information to the shop management server 400, receive the contents mapped with the beacon identification information (e.g. a beacon service corresponding to shop stay time), and provide the contents to the user.

According to a first implementation of the present disclosure, the terminal device 300 may transfer a shop list to a content information providing server by using the information received from the shop information providing device 500 to request digital contents associated with shops of high priorities in the shop list. Meanwhile, the terminal device 300 is capable of bidirectional data communications with the content information providing server and the customer database 600.

According to a second implementation of the present disclosure, when the terminal device 300 receives the beacon signal from the beacon device 200, the terminal device 300 may determine a received signal strength and a receipt time of the received beacon signal. The terminal device 300 may calculate the distance to the beacon device 200 based on the received signal strength. Also, the terminal device 300 may calculate a stay time based on the receipt time. Since the beacon device 200 periodically transmits the beacon signal, the terminal device 300 periodically receives the beacon signal until the beacon device 200 goes out of a beacon signal coverage area, and may calculate the stay time cumulatively by a number of times the beacon signal is periodically received.

Assuming that the beacon device 200 transmits the beacon signal every five seconds, the terminal device 300 will receive the beacon signal every five seconds unless it goes out of the beacon signal coverage area, and cumulatively calculates the stay time from the timing at which the beacon signal is first received.

For example, the stay time may be determined to be five seconds if two beacon signals are received while being determined to be ten seconds if three beacon signals are received.

The distance value and the stay time value calculated as above may be compared with preset thresholds for shop range information and shop stay time information, respectively. If the distance value is smaller than a preset threshold for the shop range information and the stay time value is greater than a preset threshold for the shop stay time information, the user or the terminal device may be determined to enter a shop of which beacon device transmitted the beacon signal.

In particular, the terminal device 300 may be preliminarily determined to enter the shop if the calculated distance value is smaller than the threshold for the shop range information, and may be finally determined to have entered the shop if the stay time value is greater than the threshold for the shop stay time information.

For example, when the calculated distance value is five meter while the threshold for the shop range information is ten meters, the terminal device 300 may be preliminarily determined to enter the shop since the calculated distance value is smaller than the threshold for the shop range information.

The terminal device 300 may calculate the stay time cumulatively whenever receiving the beacon signal. In case that the threshold for the shop stay time information is ten seconds, the terminal device 300 may be finally determined to have entered the shop from the timing when a cumulative stay time value exceeds ten seconds.

In case that the transmission period of the beacon signal is five seconds as above, the terminal device 300 cannot be determined to have entered the shop when the terminal device 300 receives the beacon signal twice because the cumulative stay time value is five seconds which is smaller than the threshold for the shop stay time information even through the distance value is smaller than the threshold for the shop range information. However, the terminal device 300 may be determined to have entered the shop when the terminal device 300 receives the beacon signal three times or more because the cumulative stay time value is greater than ten seconds which is the threshold for the shop stay time information

After being finally determined to have entered the shop, the terminal device 300 may continue to calculate the distance value based on the signal strength of the received beacon signal and compare the distance value with the threshold for the shop range information. The terminal device 300 may be determined to exit the shop when the distance value is larger than the threshold for the shop range information.

In other words, when the calculated distance value exceeds ten meter after the terminal device 300 is finally determined to have entered the shop, the terminal device 300 may be determined to exit the shop since the distance value is larger than the threshold for the shop range information.

Meanwhile, after being finally determined to have entered the shop, the terminal device 300 may periodically receive the beacon signal from the beacon device 200 and calculate the cumulative stay time to receive service contents of the shop corresponding to the calculated stay time from the shop management server 400 and expose the service contents to the user.

In other words, the terminal device 300 may continue to calculate the cumulative stay time after the cumulative stay time exceeds ten seconds and the terminal device 300 is finally determined to have entered the shop. In case that transmission period of the beacon signal is five seconds as above, the cumulative stay time will continue to increase to 15 seconds, 20 seconds, and 25 seconds sequentially, and the terminal device 300 will receive the service contents of the shop corresponding to the 15 seconds, 20 seconds, and 25 seconds from the shop management server 400 and expose the service contents to the user.

The service contents may be associated with shop events such as coupons or the like. The longer the cumulative stay time is, the more advantageous benefit may be prescribed for the user.

The shop range information and the shop stay time information may be stored in the terminal device 300. Alternatively, however, the information may be received from the shop management server 400.

Meanwhile, the determination of the shop entry/exit may be performed by the shop management server 400 rather than by the terminal device 300. In such a case, the terminal device 300 may transmit the signal strength information and the signal reception time information of the beacon signal to the shop management server 400 and receive the determination result regarding the shop entry/exit from the shop management server 400 together with the service contents.

According to a third implementation of the present disclosure, when the terminal device 300 receives the beacon signal from the beacon device 200, the terminal device 300 may determine the received signal strength and the receipt time of the received beacon signal, and calculate the distance to the beacon device 200 based on the received signal strength.

Also, user's situation is recognized based on sensing information measured by one or more sensors of the terminal device 300, and behavior pattern of the user is extracted based on the recognized user's situation.

The terminal device 300 may be determined to have entered the shop where the beacon device 200 is installed when the calculated distance value is smaller than the preset threshold value for the shop range information corresponding to the shop and the extracted behavior pattern matches predetermined behavior pattern information.

Here, the user's situation refers to a current behavioral situation of the user, and may represent a state of: walking, running, or being stopped.

The behavior pattern of the user may refer to a pattern of the user's situation analyzed for a predetermined time. For example, the behavior pattern may be a regular movement pattern of the user such as repetitive thirty seconds' walk and thirty seconds' stop for five minutes. Another example may be one minute running followed by three minutes' walk and one minute stop.

According to shop entry/exit determining method of the present implementation, the terminal device 300 may be preliminarily determined to enter the shop if the calculated distance value is smaller than the threshold for the shop range information, and may be finally determined to have entered the shop if the extracted behavior pattern matches preset behavior pattern information.

The behavior pattern can be set differently among the shops based on the information of the shops where the beacon devices are installed. For example, five minute's walk in a certain speed rate may be set as the preset behavior pattern in the case of a warehouse store, while repetitive three minute's walk and two minute's stop in a period of five minutes be set as the preset behavior pattern in a clothing shop

When the extracted behavior pattern is compared with the preset behavior pattern information in a final entry determination, the extracted behavior pattern may match the preset behavior pattern information incompletely rather than completely.

For example, even though an extracted pattern of three minute's walk and two minute's stop is normally determined to be identical with the preset behavior pattern in a clothing shop, another extracted pattern of two minute's stop followed by three minute's walk may also be determined to be identical with the preset behavior pattern.

The shop entry/exit determining method of the present implementation may further utilize the shop stay time information to enhance an accuracy of the determination. That is, the terminal device 300 may calculate the stay time based on the receipt time of the beacon signal received by the terminal device 300, and finally determine that the terminal device 300 has entered the shop if the stay time is greater than the preset threshold for the shop stay time information.

In other words, the terminal device 300 may be preliminarily determined to enter the shop if the calculated distance value is smaller than the threshold for the shop range information, may be determined to enter the shop for the second time if the extracted behavior pattern matches the preset behavior pattern information, and may be finally determined to have entered the shop if the stay time value is greater than the threshold for the shop stay time information.

For example, if the calculated distance value is five meters while the threshold for the shop range information is ten meters, the terminal device 300 may be preliminarily determined to enter the shop since the calculated distance value is smaller than the threshold for the shop range information.

If the extracted behavior pattern is three minute's walk followed by two minute's stop or two minute's stop followed by three minute's walk in a state that the preset behavior pattern information is three minute's walk followed by two minute's stop, the terminal device 300 may be determined to enter the shop for the second time. In case that the threshold for the shop stay time information is ten seconds, the terminal device 300 may be finally determined to have entered the shop from the timing when a cumulative stay time value exceeds ten seconds.

The stay time may be calculated based on the receipt time of the beacon signal. Since the beacon device 200 periodically transmits the beacon signal, the terminal device 300 periodically receives the beacon signal until the beacon device 200 goes out of the beacon signal coverage area, and may calculate the stay time cumulatively by the number of times the beacon signal is periodically received.

Assuming that the beacon device 200 transmits the beacon signal every five seconds, the terminal device 300 will receive the beacon signal every five seconds unless it goes out of the beacon signal coverage area, and cumulatively calculates the stay time from the timing at which the beacon signal is first received.

For example, the stay time is five seconds if two beacon signals are received, but is ten seconds if three beacon signals are received.

In addition, the preset shop range information, the preset behavior pattern information, and the preset shop stay time information may be stored in the terminal device 300. Alternatively, however, the terminal device 300 may transmit the beacon identification information to the shop management server 400 upon receiving the beacon signal, and receive the preset shop range information, the preset behavior pattern information, and the preset shop stay time information corresponding to the beacon identification information from the shop management server 400.

After being finally determined to have entered the shop, the terminal device 300 continues to calculate the distance between the beacon device 200 and the terminal device 300, when the beacon signal is received, based on the signal strength of the received beacon signal. The terminal device 300 may be determined to exit the shop when the distance value is larger than the threshold for the shop range information after the terminal device 300 have been finally determined to had entered the shop.

In other words, when the calculated distance value exceeds ten meter after the terminal device 300 have been finally determined to had entered the shop, the terminal device 300 may be determined to exit the shop since the distance value is larger than the threshold for the shop range information.

Also, after having been finally determined to had entered the shop, the terminal device 300 may periodically receive the beacon signal from the beacon device 200 and calculate the cumulative stay time to receive service contents of the shop corresponding to the calculated stay time from the shop management server 400 and expose the service contents to the user.

In other words, the terminal device 300 may continue to calculate the cumulative stay time after the cumulative stay time exceeds ten seconds and the terminal device 300 have been finally determined to had entered the shop. In case that transmission period of the beacon signal is five seconds as above, the cumulative stay time will continue to increase to 15 seconds, 20 seconds, and 25 seconds sequentially, and the terminal device 300 will receive the service contents of the shop corresponding to the 15 seconds, 20 seconds, and 25 seconds from the shop management server 400 and expose the service contents to the user.

The service contents may be associated with shop events such as coupons or the like. The longer the cumulative stay time is, the more advantageous benefit may be prescribed for the user.

In addition, after being finally determined to have entered the shop, the terminal device 300 may continue to recognize the user's situation through one or more sensors, extract the behavior pattern, and receive the service contents of the shop corresponding to the behavior pattern from the shop management server 400 and expose the service contents to the user depending on the behavior pattern extracted after the terminal device 300 have been finally determined to have entered the shop.

For example, if it is determined that the user is running or the walking speed of the user is getting faster after the terminal device 300 have been finally determined to have entered the clothing shop, it may be further determined that user is going to exit the clothing shop. In such a case, a content service such as a discount coupon may be provided to the terminal device 300 through the shop management server 400 in order to induce the user to further stay in the clothing shop.

The one or more sensors described above may be mounted in the terminal device 300, and may include a acceleration sensor, a geomagnetic sensor, a gyroscope, a proximity sensor, an luminance sensor, a temperature sensor, a humidity sensor, a barometer, and a GPS sensor. Any other sensor that may recognize the user's situation be used may be used as well.

Meanwhile, the determination of the shop entry/exit may be performed by the shop management server 400 rather than by the terminal device 300. In such a case, the terminal device 300 may transmit the signal strength information and the signal reception time information of the beacon signal along with the extracted behavior pattern information to the shop management server 400 and receive the determination result regarding the shop entry/exit from the shop management server 400 together with the service contents.

Also, the extracted behavior pattern information may be extracted by the terminal device 300 and transmitted to the shop management server 400. Alternatively, however, the sensing information detected by the one or more sensors mounted in the terminal device 300 may be transmitted to the shop management server 400, so that the shop management server 400 may recognize the user's situation based on the sensing information and extract the behavior pattern by itself based on the recognized user's situation.

The terminal device 300 may be implemented in various forms. For example, the terminal device 300 described herein may be implemented by a mobile terminal such as a smartphone, a tablet PC, a personal digital assistant (PDA), a portable multimedia player (PMP), and an MP3 player as well as a fixed terminal such as a smart TV and a desktop computer.

Besides, even though it is impossible to enumerate all types of terminals in consideration of convergence trend of digital devices, any device unit equivalent to the device units mentioned above may be used as the terminal device 300, and any device unit capable of downloading and installing the beacon service application program according to the present disclosure may be used as the terminal device 300.

The shop management server 400 may manage the beacon devices 200 installed in the shops, receive a request for a service from the terminal device 300, and provide information corresponding to the service.

The shop management server 400 provides information and services to the terminal device 300 after checking customer information of the terminal device 300 and verifying that the user is a service subscriber with reference to the customer database 600.

In addition, the shop management server 400 according to the second implementation of the present disclosure may transmit the shop range information and the shop stay time information of a shop to the terminal device 300 upon receiving a request from the terminal device 300. Also, the shop management server 400 may receive the shop entry/exit determination result from the terminal device 300 and transmit the service contents associated with the shop to the terminal device 300.

The service contents corresponding to the cumulative stay time may be transmitted to the terminal device 300. At this time, the longer the cumulative stay time is, the more advantageous benefit may be provided to the user.

Meanwhile, the determination of the shop entry/exit may be performed by the shop management server 400 rather than by the terminal device 300.

In such a case, the shop management server 400 receives the signal reception time information and the signal strength information from the terminal device 300. The receipt time information includes the time at which the terminal device 300 received the beacon signal from the beacon device 200, and the received signal strength information includes the intensity of the beacon signal when the terminal device 300 received the beacon signal from the beacon device 200.

After receiving the information, the shop management server 400 may calculate the distance between the beacon device 200 and the terminal device 300 and the stay time of the terminal device 300 based on the received information.

Also, the shop management server 400 may compare the calculated distance value and the stay time value with the shop range information and the threshold for the shop stay time information, respectively, stored previously and determine the shop entry/exit of the terminal device 300.

The shop management server 400 may preliminarily determine that the terminal device 300 enters the shop if the calculated distance value is smaller than the threshold for the shop range information, and finally determine that the terminal device 300 has entered the shop if the stay time value is greater than the threshold for the shop stay time information.

After finally determining that the terminal device 300 has entered the shop, the shop management server 400 may continue to calculate the distance value and determine that the terminal device 300 exited the shop when the distance value is larger than the threshold for the shop range information.

Also, the shop management server 400 may continue to calculate the stay time cumulatively to provide the terminal device 300 with the service contents of the shop corresponding to the calculated stay time.

Here, the service contents of which benefit is more advantageous as the cumulative stay time is longer may be provided to the terminal device 300.

The shop management server 400 may transmit the determination result to the terminal device 300 together with the service contents.

Additionally, according to the third implementation of the present disclosure, when the shop management server 400 receives a request for the shop range information, the behavior pattern information, and shop stay time information from the terminal device 300, the shop management server 400 may transmit those information to the terminal device 300, receive the entry/exit determination result from the terminal device 300, and transmit the service contents associated with the shop to the terminal device 300.

At this time, as the cumulative stay time measured by the terminal device 300 is getting longer, the more advantageous benefit may be prescribed for the user. Also, the service contents may be determined according to the behavior pattern of the user extracted after the terminal device 300 is finally determined to have entered the shop. Accordingly, the service contents associated with the cumulative stay time or the behavior pattern of the user may be transmitted to the terminal device 300.

Meanwhile, the determination of the shop entry/exit may be performed by the shop management server 400 rather than by the terminal device 300.

In such a case, the shop management server 400 may receive, from the terminal device 300, one of the received signal strength intensity information, the extracted behavior pattern information, and the sensing information measured by one or more sensors mounted in the terminal device 300, and calculate the distance between the terminal device 300 and the beacon device 200 based on the received signal strength information.

The shop management server 400 may determine that the terminal device 300 entered the shop when the calculated distance value is smaller than the threshold for the shop range information stored in the shop management server 400 and the behavior pattern information extracted by the received terminal device 300 matches the behavior pattern information stored in the shop management server 400.

If the shop management server 400 receives the sensing information measured by one or more sensors mounted in the terminal device 300 rather than receiving the behavior pattern information extracted by the terminal device 300, the shop management server 400 may recognize the user's situation based on the sensing information, extract the behavior pattern of the user based on the recognized user's situation, and compare the extracted behavior pattern with the behavior pattern information stored in the shop management server 400 to determine the shop entry/exit of the terminal device 300.

The shop management server 400 may preliminarily determine that the terminal device 300 enters the shop if the calculated distance value is smaller than the threshold for the shop range information, and finally determine that the terminal device 300 has entered the shop if the behavior pattern extracted by the terminal device 300 or the shop management server 400 matches the behavior pattern information stored in the shop management server 400.

The behavior pattern information may be set on the basis of the information of the shop at which the beacon device 200 is installed. That is, the behavior pattern information may be set differently depending on the types of shops.

This means that the behavior pattern information of a warehouse store may be set differently from the behavior pattern information of a clothing shop as mentioned above.

In order to further enhance the accuracy of the final result of the shop entry/exit determination, a tertiary determination may be made by use of the stay time information. For this purpose, the shop management server 400 may further receive the receipt time of the beacon signal from the terminal device 300 and calculate the stay time based on the receipt time. The shop management server 400 may finally determine that the terminal device 300 has entered the shop if the stay time is greater than the threshold for the shop stay time information stored in the shop management server 400.

The calculation of the staying time may be carried out similarly to the operation of the terminal device 300 described above.

The shop management server 400 may continue to calculate the distance value even after finally determining that the terminal device 300 has entered the shop, and determine that the terminal device 300 exited the shop when the distance value is larger than the threshold for the shop range information.

Meanwhile, shop management server 400 may continue to calculate the cumulative stay time to provide the service contents of the shop corresponding to the cumulative stay time to the terminal device 300.

Here, the service contents of which benefit is more advantageous as the cumulative stay time is longer may be provided to the terminal device 300.

The shop management server 400 may provide the terminal device 300 with the service contents of a shop associated with the behavior pattern of the user extracted by the shop management server 400 or the terminal device 300.

The shop management server 400 may continue to recognize the user's situation even after finally determining that the terminal device 300 has entered the shop, so that the service contents to be transmitted to the terminal device 300 may be varied according to the recognized user's situation and the behavior pattern extracted based the user's situation.

The shop management server 400 may transmit the determination result to the terminal device 300 together with the service contents.

The shop management server 400 according to the implementations of the present disclosure may have the same hardware configuration as a web server or a network server. In a software aspect, the shop management server 400 may include program modules or objects implemented by a programming language such as C, C++, Java, Visual Basic, Visual C, or the like.

The memory mounted in each of the devices of the present disclosure may shop information therein. In an implementation, the memory may be a computer-readable medium. In an implementation, the memory may be a volatile memory. In another implementation, the memory may be a nonvolatile memory. In an implementation, a storage device may be a computer-readable medium. In various modifications, the storage device may include, for example, a hard disk device, an optical disk device, or another kind of mass storage device.

Although the present specification and drawings describe exemplary device configurations, the functional operations and subject matters described herein may be implemented in other types of digital electronic circuitry, or may be formed computer software, firmware, or hardware including structures and structural equivalents thereof, and/or a combination of the hardware component and the software component. The subject matter described herein may be implemented by one or more computer program products, in other words, one or more modules of computer program instruction encoded in a intangible computer-readable program storage medium for controlling the operation of the device according to the present disclosure. The computer-readable medium may be a machine-readable storage device, a machine-readable storage substrate, a memory device, a composition of matter that affects the machine readable propagation-type signal, or a combination of one or more of the devices or the matter.

The shop information providing device 500 includes the beacon device for transmitting a signal, and may transfer collected shop information to the terminal device 300.

The customer database 600 stores information related with the terminal user or customer. For example, the information related with the terminal user may include information regarding the subscription to the contents provider and the platform service company, digital contents reception history of the customer, and list of received digital contents. The information related with the terminal user may further include another various kinds of information related with the terminal user.

Hereinafter, the configuration of the system for providing content information and determining shop entry/exit according to the implementations of the present disclosure will be described in detail.

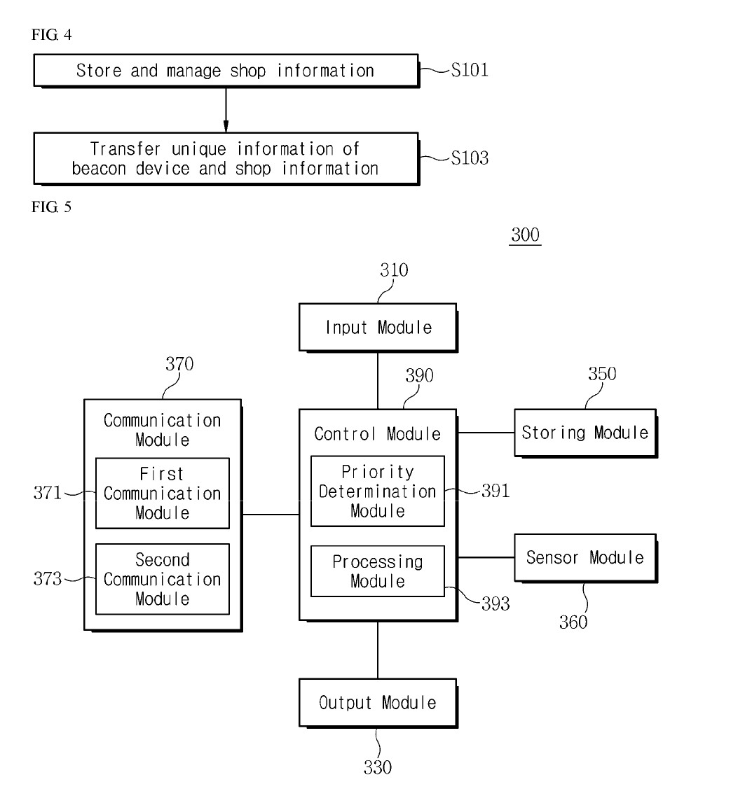

FIG. 3 is a block diagram of the shop information providing device 500 in the contents information providing system using beacon device propagation priority according to a first implementation of the present disclosure.

The shop information providing device 500 according to an implementation of the present disclosure may include a proximity sensor 510 for transferring unique identification information of the beacon device to the terminal device 300, a shop information manager 520 for storing and managing information of the shops, and a shop information transmitter 530 for transmitting the information of the shops stored in the shop information manager 520 to the terminal device 300.

The proximity sensor 510 transmits the unique identification information of the beacon device to the terminal device 300. Here, beaconing technique is used for transmitting the unique identification information. A beacon generates a signal periodically so that a signal receiver recognizes proximity from the beacon. The beacon basically has a simple structure in which the signal receiver calculates the proximity based on the received signal strength indication (RSSI), and is operable by a battery with low power consumption. However, the structure and power consumption of the beacon can vary depending on the output level and the period of the signal. The beacon can be manufactured in a small size and easily be mounted in the shop information providing device 500.

The beacon allows a precise positioning with a tolerance range of about five centimeters (cm). The coverage of the signal may extend up to 50 meters depending on the output setting, and the system may be deployed easily at each shop in a building with a wide floor. The beacon has an advantage that it allows to construct indoor and outdoor map through the precise positioning in addition to collecting shop information.

The unique identification information of the beacon device may include at least one of a media access control (MAC) address of the beacon device and another code in the beacon signal. The MAC address is a unique identifier assigned to network interface controllers (NICs).

The shop information manager 520 stores and manages the unique information of the beacon device and the shop information received from the terminal device 300. The shop information may include at least one of: business type of the shop, size of the shop, number of products in the shop, number of employees, number of daily visiting customers, and number of customers currently in the shop. The shop information may be used as a basis for sorting the shop list in the terminal device 300.

The shop information transmitter 530 transfers the shop information to the terminal device 300. The shop information transmitter 530 is necessary since the proximity sensor 510 transfers only the unique information of the sensor. Accordingly, detailed information of the shop is transmitted to the terminal device 300 through the shop information transmitter 530. With this configuration, the terminal device 300 may receive the information of the shop at which the beacon device is installed, along with the information transferred by the proximity sensor 510.

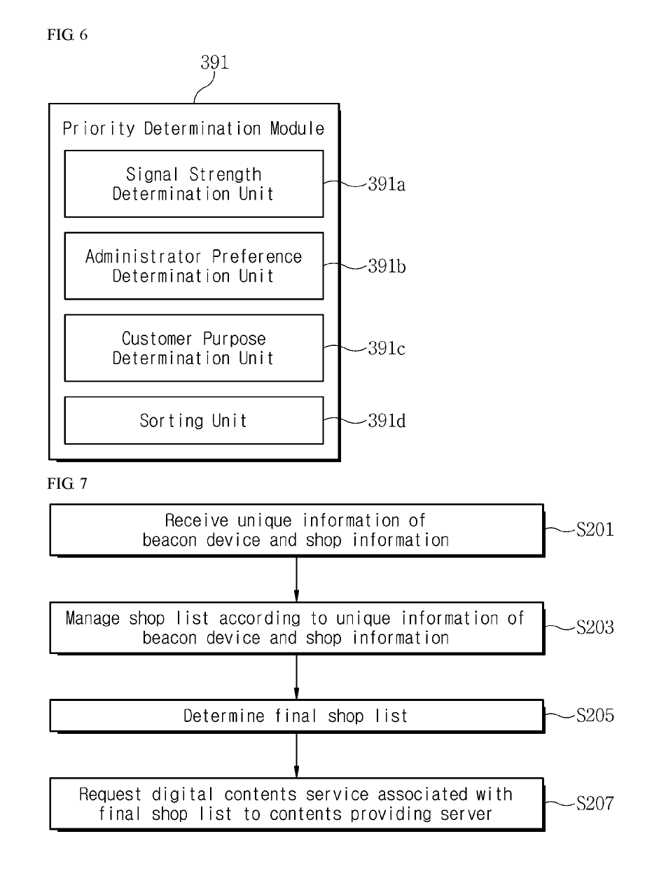

FIG. 4 is a flowchart illustrating a method that the shop information providing device 500 according to the first implementation of the present disclosure provides shop information and the unique identification information of the beacon device.

The method that the shop information providing device 500 provides the contents information service using beacon device priorities according to an implementation of the present disclosure includes an operation of managing shop information (S101) and an operation of transferring unique identification information of the beacon device and the shop information (S103). In more detail, the shop information manager 520 of the shop information providing device 500 stores and manages the shop information in the operation S101, and transfers the unique identification information of the beacon device and the shop information to the terminal device 300 in the operation S103.

In more detail, the shop information manager 520 of the shop information providing device 500 stores and manages the shop information in the operation S101. Here, the shop information may include at least one of: the business type of the shop, the size of the shop, the number of products in the shop, the number of employees, the number of daily visiting customers, and the number of customers currently in the shop. The shop information may be used as a basis for sorting the shop list in the terminal device 300.

In the operation S103, the shop information transmitter 530 transmits the shop information stored in the shop information manager 520 to the terminal device 300, and the proximity sensor 510 transmits the unique information of the beacon device to the terminal device 300. The unique information of the beacon device maintained in the shop information providing device 500 includes at least one of the MAC address of the beacon device and the strength of the transmitted beacon signal.

In the operation S103, the process of transferring the unique information of the beacon device may be carried out separately from the process of storing and transmitting the shop information to the terminal device 300. It is because the proximity sensor 510 transmits only the unique information of the sensor, and a separate transmitter 250 for transmitting the shop information is required.

Thus, the shop information transmitter 530 may transmit detailed shop information to the terminal device 300, and the terminal device 300 may receive the shop information of the shop at which the beacon device 510 is installed together with the information transmitted from the proximity sensor 510.

The configuration and operation of the terminal device 300 according to the present disclosure will now be described in detail.

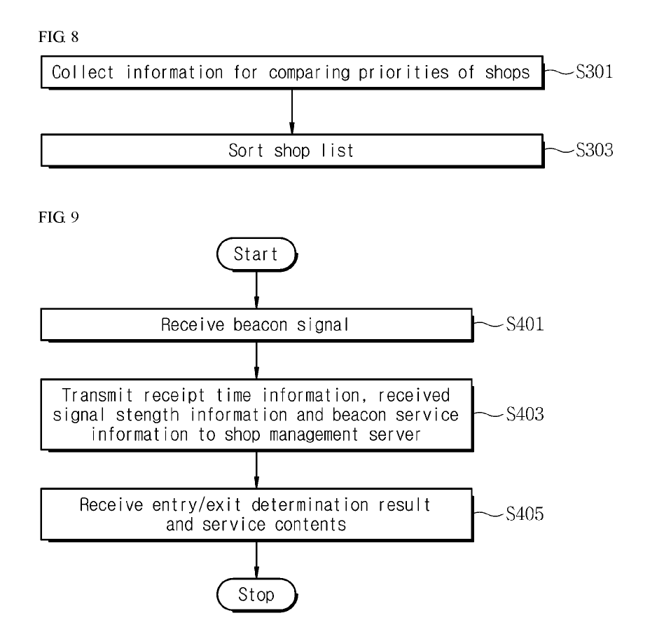

Referring to FIG. 5, the terminal device 300 may include an input module 310, an output module 330, a storage module 350, a sensor module 360, a communication module 370, and a control module 390.

The input module 310 receives various information such as numbers and characters, and transfers signals related with function setting and function control of the terminal device 300 to the control module 390. The input module 310 may include at least one of a keypad and a touchpad that generates an input signal according to a touch or manipulation of the user. The input module 310 and the output module 330 may be incorporated into a single touch panel (or a touch screen) that may perform both the input and display functions. Any other type of input device that may be developed and available in the future in addition to an input device such as a keyboard, the keypad, a mouse, a joystick, and the like may be used as the input module 310. In particular, the input module 310 may detect the information input by the user and transmit the input information to the control module 390.

The output module 330 displays information of a series of operation states and operation results during the operation of the terminal device 300. The output module 330 may display a menu of the terminal device 300 and user input data. The output module 390 may be a liquid crystal display (LCD), a thin film transistor LCD (TFT-LCD), a light emitting diode (LED), an organic light emitting diode (OLED), an organic light emitting diode (OLED), an active-matrix organic light emitting diode (AMOLED), a retina display, a flexible display, or a three-dimensional display. When the output module 330 is implemented in a form of a touch screen, the output module 330 may perform some or all of the functions of the input module 310.

In particular, the service contents received from the shop management server 400 may be exposed to the user through the output module 330.

The storage module 350, which is device for storing data, includes a main storage device and an auxiliary storage device and stores application programs required for the functional operation of the terminal device 300. The storage module 350 may include a program region and a data region. When a function of the terminal device 300 is activated in response to a request of the user, a corresponding application program is executed under the control of the control module 390 to perform the function.

The storage module 350 may further store an operating system for booting the terminal device 300, various application programs, user information matched to the terminal device 300, and the like.

The storage module 350 according to the first implementation of the present disclosure manages a shop list according to the unique information of the beacon device and the shop information received by the communication module 370. Here, the storage module 350 may assign a rank or priority to each of the shops based on the distances from respective beacon devices calculated using the received signal strength so as to use the priorities in sorting the shop list.

Data managed by the storage module 350 may include the MAC address, the signal strength of the received beacon signal (RSSI), the business type of the shop, the size of the shop, the number of products in the shop, the number of employees, the number of daily visiting customers, and the number of customers currently in the shop. The shop information may be used as a basis for sorting the shop list in the terminal device 300.

Also, the data stored and managed by the storage module 350 may further include a beacon service application for providing the beacon service according to the second and third implementations of the present disclosure. The stored data may further include the shop range information, the behavior pattern information, and the shop stay time information of the shop corresponding to the beacon device 200 that transmitted the received beacon signal

The sensor module 360 outputs sensing information measured by one or more sensors mounted in the terminal device 300.

The sensing information may include information representing a physical change in the vicinity of the terminal device 300. The control module 390 may recognize the user's situation such as walking, running, and stop through the physical change, and the behavior pattern of the user may be extracted based on the recognized situation information.

The communication module 370 transmits and receives data to and from the shop management server 400 through the communications network 100, and receives signals transmitted periodically by the beacon device 200.

The communication module 370 may include a RF transmitter for up-converting a frequency band of a transmit signal and amplifying a up-converted signal, a RF receiver for low-noise amplifying a received signal and down-converting a frequency band of the received signal, and a data processor for processing a communication protocol of a predetermined communication scheme. The communication module 370 may include at least one of a wireless communication module (not shown) and a wired communication module (not shown). The wireless communication module is provided to support transmission and reception of data according to a wireless communication scheme. When the terminal device 300 uses the wireless communication scheme, the wireless communication module may transmit or receive data to and from the shop management server 400 by using at least one of a wireless network communication module, a wireless LAN communication module, and a wireless Personal Area Network (PAN) communication module.

The communication module 370 may include a first communication module 371 and a second communication module 373.

The first communication module 371 may receive a signal transmitted by the beacon device 200. The first communication module 371 may perform the PAN communications that use Bluetooth, for example, as mentioned above.

The second communication module 373 communicates with the shop management server 400 through the communications network 100. The second communication module 373 may communicate through a wireless communication network such as the Wireless LAN (WLAN), the Wi-Fi network, the Wibro network, the WiMAX network, and the HSDPA network.

The control module 390 may include an operating system (OS) and processes that drive other configurations of the terminal device 300.

The control module 390 of the terminal device 300 may control the signal received through the input module 310 to be transmitted to the shop management server 400 through the communication module 370, control the beacon signal received through the communication module 370 or the information received from the shop management server 400 to be exposed through the output module 330, and control these information and data to be stored in the storage module 350.

The control module 390 according to the first implementation of the present disclosure may include a priority determination module 391 and a processing module 393.

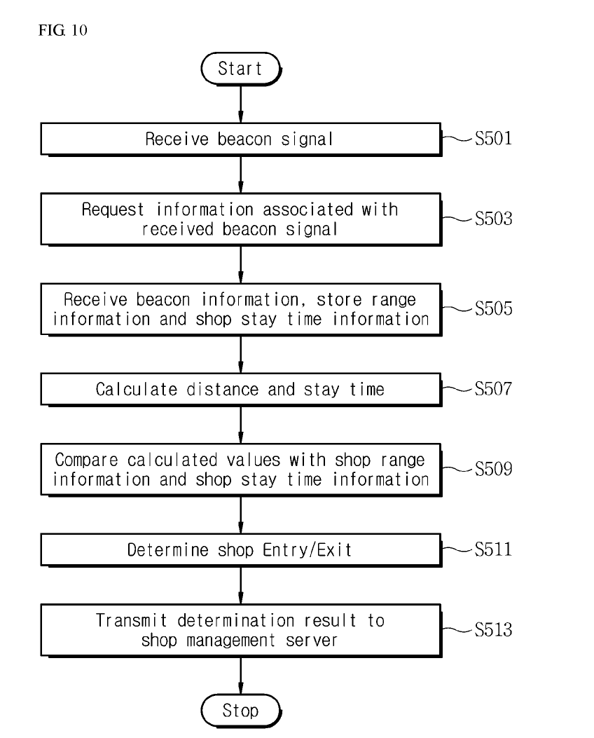

Referring to FIG. 6, the priority determination module 391 may include a signal strength measurement unit 391A, an administrator preference determination unit 391B, a customer purpose determination unit 391C, and a sorting unit 391D.

In more detail, the priority determination module 391 may include the signal strength measurement unit 391A for measuring the received signal transmitted by the shop information providing device 500, the administrator preference determination unit 391B for determining the preference of an administrator providing the contents service, the customer purpose determination unit 391C for determining the purpose of using a service and product of the terminal user receiving the contents service, and the sorting unit 391D for sorting the shop list based on priority comparison basis information provided by the signal strength measurement unit 391A, the administrator preference determination unit 391B, and the customer purpose determination unit 391C.

The signal strength measurement unit 391A measures the received signals transmitted by the shop information providing devices 500.

Here, the signal strength measurement unit 391A measures the received signal strength indicator (RSSI) of the radio signal transmitted by the shop information providing device 500. The received signal strength may be changed depending on the distance from the shop information providing device 500 to the terminal device 300.

The administrator preference determination unit 391B determines the administrator preference providing the contents service. The administrator preference refers to the administrator preference to the user of the terminal device, and may be determined based on at least one information of: a number of times that the terminal user has used the service provided by the administrator, whether or not the user agreed to provide the location information, the location of the terminal device identified by provided location information, age/sex of the terminal user, and whether or not the user subscribed to the application associated with the provided service.

The preference may be categorized into three steps of ‘high’, ‘middle’, and ‘low’. The preference may be determined to be ‘high’, ‘middle’, or ‘low’ after evaluating one or more of the criterions of: whether the number of times of using the service is larger than a predetermined number, whether the number of times of accessing the service after having agreed to provide the location information is greater than a predetermined number, whether the terminal user agrees to provide the location information in real time, whether the age of the user is within a predetermined range, and whether the user subscribed to the application of a service platform provider, for example. The preference evaluation may be performed in a manner other than the above-described method, such as scoring and categorizing into more levels of depths.

The customer purpose determination unit 391C determines the purpose of using goods or services of the terminal user receiving the contents service. The customer purpose determination unit 391C may determine the purpose of the terminal user by using at least one of: preference of the terminal user for the goods and services, a price range of the good or the service, and product type information.

The preference of the terminal user for the goods and services may be determined by using outsiders' evaluation for the good or the service and the terminal user's evaluation for the good or the service. The price range of the good or the service may be determined by applying criteria for maximum and minimum prices. The product type in the product type information refers to a product item itself. In other words, the product type means the product item such as sporting goods, housewares, and so on, and may be determined with reference to an item similar to a product item desired by the terminal user. Information of the service and the product may be chosen by the user on an application provided by the service platform provider, or may be selected based on history information of purchasing services and products in the past stored in the customer database 600.

The sorting unit 391D sorts the shop list based on the priority comparison basis information provided by the signal strength measurement unit 391A, the administrator preference determination unit 391B, and the customer purpose determination unit 391C.

The sorting unit 391D may sort the shop list after applying weighting factors to each of the priority comparison basis information provided by the signal strength measurement unit 391A, the administrator preference determination unit 391B, and the customer purpose determination unit 391C. The sorting unit 391D may choose basis information to which the weighting factors are to be applied. Instead of applying the weighting factors, the sorting unit 391D may choose at least one of the priority comparison basis information provided by the signal strength measurement unit 391A, the administrator preference determination unit 391B, and the customer purpose determination unit 391C, and sort the shop list based on only the chosen basis information.

The processing module 393 constructs a final shop list including the shops of the highest priorities among the candidate shops taking the shop information into account, and transfers the final shop list to communication module 370.

The processing module 393 provides the digital contents provider or the platform service provider with the final shop list indicating the shops having highest priorities of which digital contents are to be provided most preferentially to the terminal device among a number of shops.

The shop information that is taken into account in determining the candidate shops that may be included in the final shop list may include at least one of: the business type of the shop, the size of the shop, the number of products in the shop, the number of employees, the number of daily visiting customers, and the number of customers currently in the shop. The shop information may be used as a basis for sorting the shop list in the terminal device 300. The shops to be included in the final shop list may be determined based on the shop information as well as information whether the terminal user is staying in the shop or has moved to another shop. The final shop list may be transferred to the communication module 370 as mentioned above.

Since it is finally checked whether the terminal user is staying in the shop or has moved to another shop, it is possible to provide the digital contents associated with the corresponding shop more accurately to the terminal device.

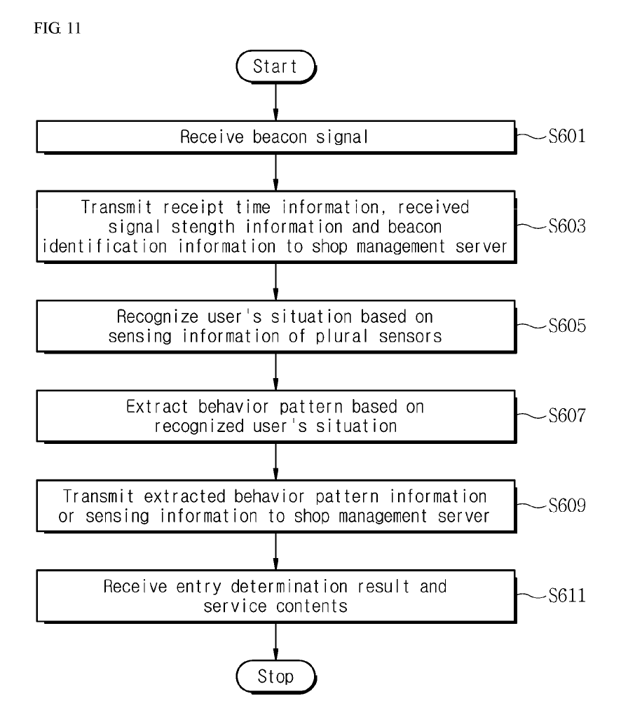

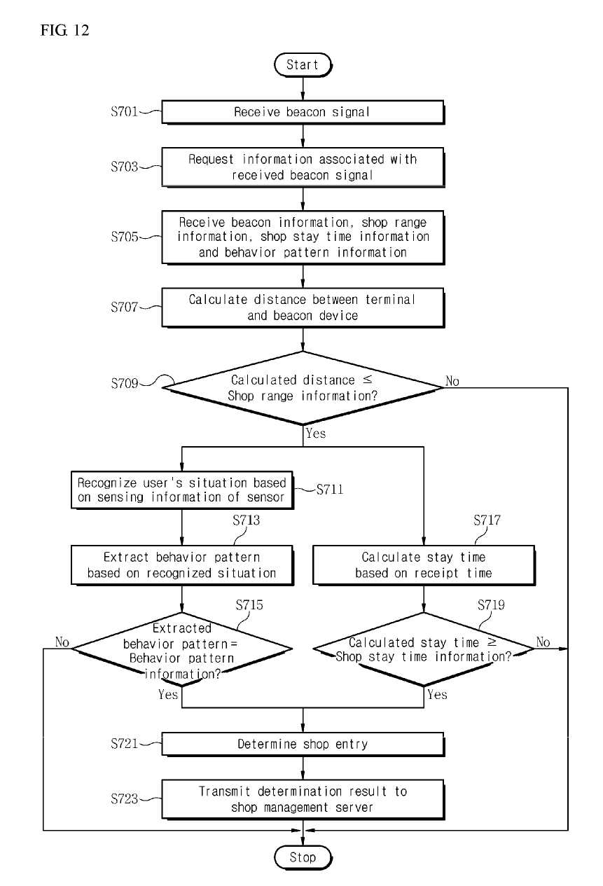

The operation of the terminal device 300 according to the first implementation of the present disclosure, which is generally controlled by the control module 390 including the priority determination module 391 and the processing module 393, will now be described in detail with reference to FIGS. 7 and 8.

FIG. 7 is a flowchart illustrating a method of providing contents information service using the beacon device propagation priority according to the first implementation of the present disclosure.

The method that the terminal device 300 according to the first implementation of the present disclosure provides the contents information service using beacon device priorities may include receiving the unique information of the beacon device and the shop information (S201), managing the shop list (S203), determining the shop list (S205), and requesting contents service (S207). In more detail, the method of providing the contents information service may include: (a) receiving the unique information of the beacon device installed in each of one or more shops and the shop information provided by the shop information providing devices 500 (S201); (b) maintaining the shop list according to the unique information of the beacon device and the shop information (S203); (c) determining a final shop list including shops of the highest priorities among the candidate shops taking the shop information into account and transferring the final shop list to the transmitter 250 (S205), and (d) requesting the shop management server 400 for digital contents service associated with the final shop list (S207).

In the operation S201, the terminal device 300 receives the unique information of the beacon device installed in each of a plurality of shops and the shop information provided by the shop information providing devices 500. The terminal device 300 may determine priorities of the shops by using the signals transmitted from the respective shops, and can simultaneously process the unique information and shop information for the plurality of shops.

In the operation S203, the terminal device 300 manages the shop list according to the unique information of the beacon device and the shop information received in the operation S201. At this time, the sorting of the shop list may be carried out on the basis of the received signal strength among the unique information received in the operation S201. In case that only the received signal strength is taken into account, the contents information associated with the nearest shop can be acquired quickly because the content providing service may be performed using only the information transmitted by the proximity sensor 510 of the shop information providing device 500.

In the operation S205, the terminal device 300 determines the final shop list including shops of the highest priorities among the candidate shops taking the shop information into account and transfers the final shop list to the transmitter 250

In the operation S207, the terminal device 300 requests the shop management server 400 to provide the digital contents service associated with the final shop list. The shop information that is taken into account in the operation S205 in determining the candidate shops that may be included in the final shop list may include at least one of: the business type of the shop, the size of the shop, the number of products in the shop, the number of employees, the number of daily visiting customers, and the number of customers currently in the shop. The shops to be included in the final shop list may be determined based on the shop information as well as the information whether the terminal user is staying in the shop or has moved to another shop.

Examples of the digital contents may include a coupon for goods and services provided by the shop contained in the final shop list, and a digital guide to guide the user to the shop when it may be difficult to find the shop.

FIG. 8 is a flowchart illustrating a method that the terminal device 300 sorts the shop list based on the priorities assigned to the shops according to the first implementation of the present disclosure.

The method that the terminal device 300 sorts the shop list based on the priorities of the shops may include collecting information for comparing the priorities of the shops (S301), and sorting the shop (S303). In more detail, the method of sorting the shop list may include: measuring the received signals transmitted by the shop information providing devices 500 and collecting information for use in comparing the shop priorities based on the preference for the terminal user of the administrator who provides the contents service and the purpose of the user to use the good or the service (S301); and sorting the shop list based on the information collected in the operation S301 for use in comparing the shop priorities (S303).

In the operation S301, the terminal device 300 measures the received signals transmitted by the shop information providing devices 500, and collects the information for use in comparing the shop priorities based on the preference for the terminal user of the administrator who provides the contents service and the purpose of the user to use the good or the service.

First, the terminal device 300 measures the received signals transmitted by the shop information providing devices 500. In more detail, the terminal device 300 measures the received signal strength indicator (RSSI) for the signals transmitted by the shop information providing devices 500. The received signal strength may be varied according to the distance from the terminal 500 to the shop information providing device 500.

Second, the terminal device 300 determines the preference for the terminal user of the administrator providing the contents service. Here, the administrator is a service provider, and the administrator preference may be determined based on at least one information of: the number of times that the terminal user has used the service provided by the administrator, whether or not the user agreed to provide the location information, the location of the terminal device identified by provided location information, the age and sex of the terminal user stored in the customer database 600, and whether or not the user subscribed to the application associated with the provided service.

Third, the terminal device 300 determines the purpose of using goods or services of the terminal user who receives the contents service. The purpose of the terminal user may be determined by using at least one of: the preference of the terminal user for the good or the service, the price range of the good or the service, and the product type information.

In the operation S303, the shop list is sorted based on the information collected for use in comparing the shop priorities. When the shop list is sorted based on the priority comparison basis information, the weighting factors may be applied to each of the priority comparison basis information. Alternatively, the weighting factors may be applied to only some of the priority comparison basis information. In another alternative implementation, some of the priority comparison basis information may be chosen to be used in sorting the shop list without any weighting factors.

As described above, according to the present disclosure, the sensor information received from a plurality of beacon devices installed in respective one of a plurality of shops or a shop complex not being compartmentalized may be processed effectively by utilizing the received signal strength information, and the possibility that the digital contents are treated as spam may be reduced. Also, since one of the shops is selected in consideration of the administrator preference and the customer's purpose of using the product in addition to the received signal strength, and services associated with the selected shop is provided to the terminal device, contents customized to the administrator or the customer may be provided to the user.

Since the intention of the user and the administrator providing the digital contents service are taken into account when the service is provided, the marketing efficiency may be enhanced. Furthermore, since providing of the contents are influenced by the situation of each shop, the present disclosure may be utilized in a clicks and bricks business. In the case that the shops are not compartmentalized, the present disclosure may be utilized to construct an indoor/outdoor map information to provide relevant services to the terminal users and the like.

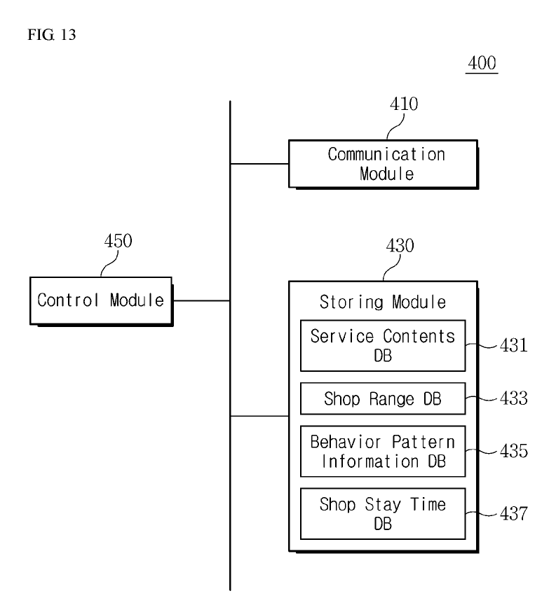

The operation of the terminal device 300 according to the second implementation of the present disclosure and the control of control module 390 will now be described in detail with reference to FIGS. 9 and 10.

FIG. 9 shows the operation of the terminal device 300 controlled by the control module 390 according to a second implementation of the present disclosure. Referring to FIG. 9, when the terminal device 300 receives the beacon signal periodically transmitted by the beacon device 200 (S401), the terminal device 300 may transmit the receipt time information and the received signal strength information of the received beacon signal along with the beacon service information corresponding to the received beacon signal to the shop management server 400 (S403). When the shop management server 400 determines the shop entry/exit of the terminal device 300, the terminal device 300 may receive the determination result and the service contents corresponding to the beacon signal (S405).

FIG. 10 shows the operation of the terminal device 300 controlled by the control module 390 according to another second implementation. Referring to FIG. 10, when the terminal device 300 receives the beacon signal periodically transmitted by the beacon device 200 (S401), the terminal device 300 may request the shop management server 400 for the shop range information and the shop stay time information of the shop corresponding to the received beacon signal, and receive these information from the shop management server (S503, S505). However, the shop range information and the shop stay time information are not necessarily received from the shop management server 400, but may be stored in the terminal device 300 in advance.

If those information is stored in the terminal device 300 in advance, the operations S503 and S505 may be omitted.

The terminal device 300 may calculate the distance between the beacon device 200 and the terminal device 300 based on the signal strength of the received beacon signal and calculate the stay time based on the receipt time of the beacon signal (S507). The stay time may be calculated cumulatively. For example, assuming that the beacon device 200 transmits the beacon signal every five seconds, the stay time may be calculated to be five seconds if two beacon signals are received while being calculated to be ten seconds if three beacon signals are received.

If the terminal device 300 receives the beacon signal at 13:05:30 and continues to receive the beacon signal until receiving the last beacon signal at 13:20:30, the stay time would be calculated to be fifteen minutes.

The terminal device 300 compares the calculated distance value and the stay time value with the shop range information and the shop stay time information (S509). The terminal device 300 may be preliminarily determined to enter the shop if the calculated distance value is smaller than the threshold for the shop range information (e.g., the calculated distance value is five meters while the threshold for the shop range information is set to ten meters). The terminal device 300 may be finally determined to have entered the shop if the calculated stay time value is greater than the threshold for the shop stay time information (e.g., the calculated stay time value is ten minutes while the threshold for the shop stay time information is five minutes) (S511).

The terminal device 300 may transmit the determination result to the shop management server 400 (S513).

After being finally determined to have entered the shop, the terminal device 300 may be determined to exit the shop when the calculated distance value is getting larger than the threshold for the shop range information.

The thresholds for the shop range information and the shop stay time information may be statistically set for each industrial field or each brand based on the type of the shop, the industrial field, a location of the shop, and other attributes of the shop. Also, the thresholds may be set for each shop separately as well.

In particular, the threshold for the shop stay time information may be set for each user separately after profiling the purchasing pattern and the consumption propensity of the user of the terminal device 300 and an average stay time in the industrial field in addition to the attributes of the shop.

When the terminal device 300 is determined to have entered the shop, the terminal device 300 may continue to calculate the stay time cumulatively and receive service contents associated with the cumulative stay time periodically or aperiodically from the shop management server 400 to expose through the output module 330.

The operation of the terminal device 300 according to the third implementation of the present disclosure and the control of control module 390 will now be described in detail with reference to FIGS. 11 and 12.

FIG. 11 shows the operation of the terminal device 300 controlled by the control module 390 according to a third implementation. Referring to FIG. 11, when the terminal device 300 receives the beacon signal periodically transmitted by the beacon device 200 (S601), the terminal device 300 may transmit beacon identification information corresponding to the received beacon signal together with the receipt time information and the received signal strength information of the received beacon signal to the shop management server 400 (S603).

Also, the situation of the user of the terminal device 300 is recognized based on the sensing information measured by one or more sensors (S605), the behavior pattern of the user is extracted based on the recognized user's situation (S607), and the extracted behavior pattern information may be transmitted to the shop management server 400.

At this time, instead of extracting the behavior pattern of the user, the terminal device 300 may transmit the sensing information measured by one or more sensors to the shop management server 400 (S609).

That is, the steps S605 and S607 may be omitted, and the sensing information measured by one or more sensors may be transmitted directly to the shop management server 400.

After the shop management server 400 determines the shop entry/exit of the terminal device 300, the terminal device 300 may receive the determination result and the service contents corresponding to the beacon signal (S611).

FIG. 12 shows the operation of the terminal device 300 controlled by the control module 390 according to another third implementation. Referring to FIG. 12, when the terminal device 300 receives the beacon signal periodically transmitted by the beacon device 200 (S701),

the terminal device 300 may request the shop management server 400 for the shop range information and the shop stay time information of the shop corresponding to the received beacon signal, the behavior pattern information, and the beacon information, and receive these information from the shop management server (S703, S705). However, the shop range information, the shop stay time information, and the behavior pattern information are not necessarily received from the shop management server 400, but may be stored in the terminal device 300 in advance.

If those information is stored in the terminal device 300 in advance, the operations S703 and S705 may be omitted.

The terminal device 300 may calculate the distance between the beacon device 200 and the terminal device 300 based on the signal strength of the received beacon signal (S507). The terminal device 300 may compare the calculated distance value with the shop range information, and may preliminarily determine that the terminal device 300 enters the shop if the calculated distance value is smaller than the threshold for the shop range information (S709).

For example, if the calculated distance value is five meters while the threshold for the shop range information is set to ten meters, the terminal device 300 may preliminarily determine the entry into the shop.

Also, the user's situation is recognized based on sensing information measured by one or more sensors (S711), the behavior pattern of the user is extracted based on the recognized user's situation (S713), and it is determined whether the extracted behavior pattern matches the behavior pattern information (S715). If the extracted behavior pattern matches the behavior pattern information (for example, the preset behavior pattern information is a pattern including three minute's walk followed by two minute's stop, and the extracted behavior pattern is three minute's walk followed by two minute's stop or two minute's stop followed by three minute's walk), the terminal device 300 may finally determine the entry into the shop and transmit the determination result to the shop management server 400 (S721 and S723).

Meanwhile, after the preliminary determination of the entry into the shop, the terminal device 300 may calculate the stay time based on the receipt time of the beacon signal (S717). If the calculated stay time is greater than the threshold for the shop stay time information (for example, the threshold for the shop stay time information is five minutes, and the calculated stay time is ten minutes), the terminal device 300 may finally determine the entry into the shop (S719 and S721) and transmit the determination result to the shop management server 400 (S723).

The determinations of the entry into the shop using the behavior pattern information and the stay time information are not necessarily performed in parallel but may be performed serially.

That is, after the operation S709, the operations S711 through S715 may be executed first. When the extracted behavior pattern matches the behavior pattern information, the operations S717 and S719 may be executed. Subsequently, in case that the calculated stay time is greater than the threshold for the shop stay time information, the process proceeds to the operation S721.

The execution order of the operations S711 through S715 and the operations S717 and S719 may be reversed. That is, after the operation S709, the operations S717 and S719 may be executed first, and then the operations S711 through S715 may be executed. In case that the determinations in the operations S717 and S713 satisfy respective criteria, the process may proceed to the operation S721.

Meanwhile, after being finally determined to have entered the shop, the terminal device 300 may continue to calculate the distance value based on the signal strength of the received beacon signal and determine that the terminal device 300 exited the shop when the distance value is getting larger than the threshold for the shop range information.

The behavior pattern may be set differently among the shops based on the information of the shops where the beacon devices are installed, e.g. the type of the shop and the type of the products.

The overall operation of the terminal device 300 according to the implementations of the present disclosure may be controlled by the control module 390 of the terminal device 300.

The configuration and operation of the terminal device 300 according to the present disclosure have been described above.

Hereinbelow, the configuration and operation of the shop management server 400 according to the present disclosure will be described in detail.

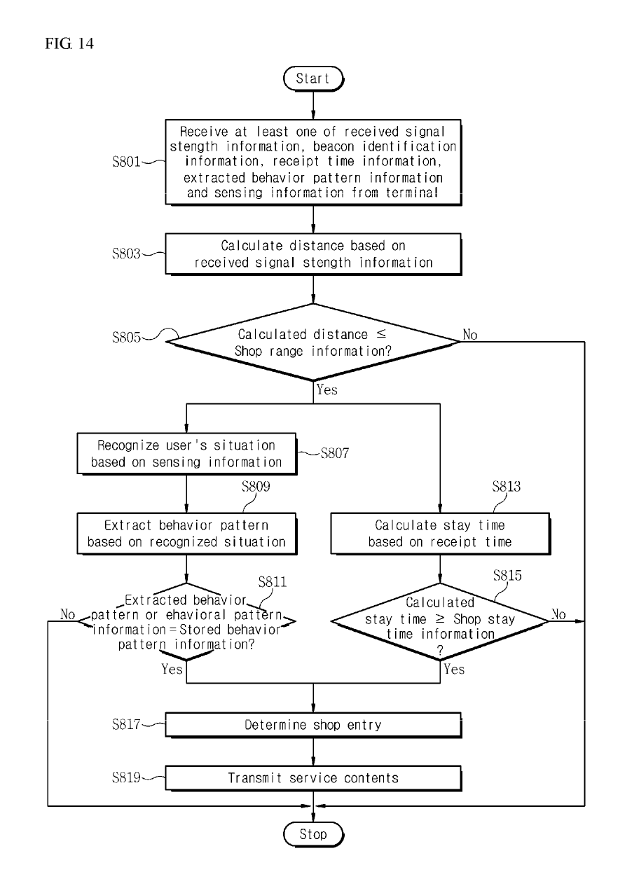

Referring to FIG. 13, the shop management server 400 according to the present disclosure may include a communication module 410, a storage module 430, and a control module 450.

The communication module 410 is configured to communicate with the terminal device 300 through the communications network 100. The communications network 100 may be a wireless network such as the WLAN, the Wi-Fi network, the Wibro network, the WiMAX network, and the HSDPA network. However, the present disclosure is not limited thereto, but the communications network 100 may include a wired communications network such as the Ethernet, the xDSL (ADSL or VDSL) network, the HFC network, the FTTC network, and the FTTH network.

In particular, the communication module 410 may transmit the shop range information, the behavior pattern information, the shop stay time information, and the service contents associated with a shop corresponding to the beacon device 200 to the terminal device 300 through the communications network 100. Also, the communication module 410 may further transmit the determination result for the shop entry/exit to the terminal device 300.

Also, the communication module 410 may receive the received signal strength information and the signal reception time information of the beacon signal, the sensing information, and the extracted behavior pattern information from the terminal device 300, and may further receive the service content transmission request from the terminal device 300.

The storage module 430, which is device for storing data, includes a main storage device and an auxiliary storage device and stores application programs required for the functional operation of the shop management server 400. The storage module 430 may include a program region and a data region. When a function of the shop management server 400 is activated, a corresponding application program is executed under the control of the control module 450 to perform the function.

In particular, the storage module 430 according to the present disclosure may store a service contents information DB 431, a shop range DB 433 for storing the range information for each shop, the behavior pattern information DB 435 for storing the behavior pattern information corresponding to each shop, and a shop stay time DB 437 for storing the shop stay time information for each shop or each user of the terminal device 300.

The service contents information DB 431 may store information of the service contents to be exposed at the terminal device 300 correspondingly to the identification information contained in the beacon signal periodically transmitted by the beacon device 200 installed in each shop

The shop range DB 433 stores the shop range information for each shop. The shop range information may be statistically set for each industrial field or each brand based on the type of the shop, the industrial field, a location or area of the shop, main customers, and other attributes of the shop. Also, the shop range information may be set for each shop separately as well.

The behavior pattern information DB 435 stores the behavior pattern information corresponding to each shop. The behavior pattern information may be statistically set for each industrial field or each brand based on the type of the shop, the industrial field, a location or area of the shop, main customers, and other attributes of the shop, similarly to the shop range information. Also, the behavior pattern information be set for each shop separately as well.

Also, the behavior pattern information may be set for each user separately after profiling the purchasing pattern and the consumption propensity of the user of the terminal device 300 and the average stay time in the industrial field.

The shop stay time DB 437 stores the shop stay time information for each shop. The shop stay time information may be statistically set for each industrial field or each brand similarly to the shop range information and the behavior pattern information, or may be set for each shop separately. Also, the shop stay time information may be set for each user according to the profiles of the user of the terminal device 300.

The control module 450 may determine the shop entry/exit of the terminal device 300 according to the receipt time and the signal strength of the beacon signal that the terminal device 300 received from the beacon device 200, and the extracted behavior pattern.

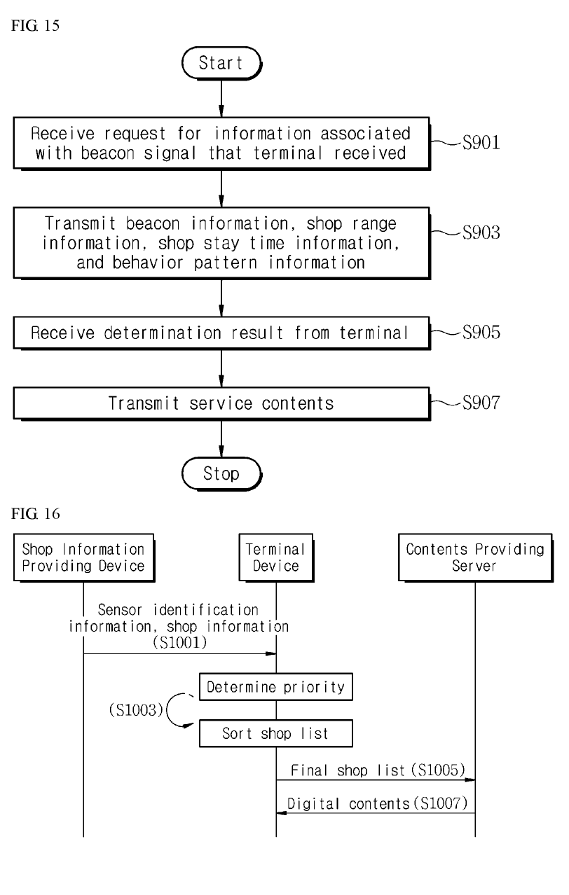

The method that the control module 450 determines the shop entry/exit of the terminal device 300 and controls the overall operation of the shop management server 400 will now be described with reference to FIGS. 14 and 15.

FIG. 14 shows the operation of the shop management server 400 according to an implementation of the present disclosure. Referring to FIG. 14, the shop management server 400 may receive, from the terminal device 300, the received signal strength information and the beacon identification information of the beacon signal received by the terminal device 300. The shop management server 400 may further receive at least one of: the behavior pattern information extracted by the terminal device 300, the sensing information measured by one or more sensors mounted in the terminal device 300, and the receipt time information of the beacon signal (S801).

The shop management server 400 calculates the distance between the terminal device 300 and the beacon device 200 based on the received signal strength (S803), and compares the calculated distance value with the stored shop range information (S805). If the calculated distance value is smaller than the stored threshold for the shop range information, the shop management server 400 preliminarily determines that the terminal device 300 entered the shop. Subsequently, the shop management server 400 recognizes the user's situation based on the sensing information (S807), and extracts the behavior pattern of the user based on the recognized user's situation (S809). When the extracted behavior pattern matches the stored behavior pattern information (S811), the shop management server 400 may finally determine that the terminal device 300 entered the shop (S817) and transmit the service contents associated with the shop to the terminal device 300 (S819).

Meanwhile, in case that the shop management server 400 receives the behavior pattern information extracted by the terminal device 300 instead of the sensing information in the operation S801, the operations S807 and S809 may be omitted. In such a case, the shop management server 400 may compare the received behavior pattern information with the stored behavior pattern information, and finally determine that the terminal device 300 entered the shop when the received behavior pattern matches the stored behavior pattern information in the operation S811.

On the other hand, when the calculated distance is smaller than the threshold for the shop range information in the operation S805, the shop management server 400 may calculates the stay time which represents the time for the terminal device 300 to stay in the shop based on the received receipt time information (S813). If the calculated stay time is greater than the threshold for the stay time information (S815), the shop management server 400 may finally determine that the terminal device 300 entered the shop (S817) and transmit the service contents associated with the shop to the terminal device 300 (S819).

Here, the determinations of the entry into the shop using the behavior pattern information and the stay time information shown in FIG. 14 are not necessarily performed in parallel but may be performed serially similarly to the operation of the terminal device 300 shown in FIG. 12.

That is, the operation S813 and S815 may be executed after the execution of the operations S807 through S811. Conversely, the operation S807 through S811 may be executed after the execution of the operation S813 and S815. When the determinations in the operations S811 and S815 satisfy respective criteria, the process may proceed to the operation S817.

Meanwhile, if the shop management server 400 continuously receives the signal strength information of the beacon signal received by the terminal device 300 after determining that the terminal device 300 have entered the shop, the shop management server 400 may continue to calculate the distance value based on the received signal strength information. The shop management server 400 may determine that the terminal device 300 exited the shop when the distance value is getting larger than the threshold for the shop range information.

FIG. 15 shows the operation of the shop management server 400 according to another implementation. Referring to FIG. 15, upon receiving a message requesting to transmit the shop range information of the shop corresponding to the beacon signal received by the terminal device 300, the behavior pattern information, the beacon information, and the shop stay time information (S901), the shop management server 400 transmits the requested information to the terminal device 300 (S903). After the terminal device 300 determines the shop entry/exit of the terminal device 300, the shop management server 400 may receive the determination result (S905) and provide the service contents associated with the received result to the terminal device 300 (S907).

The service contents may be determined according to the stay time value of the terminal device 300 that is received together with the determination result from the terminal device 300. As the stay time value is getting longer, the more beneficial service contents may be provided to the terminal device 300. After the determination of the shop entry/exit of the terminal device 300, the user's situation is continuously collected and recognized to provide an optimum service content to the terminal device 300 depending on the user's situation.

Here, the optimum service content may be a service content that may induce the user to stay further in the shop when the user is likely to leave the shop.

The overall operation of the shop management server 400 described above may be controlled by the control module 450 of the shop management server 400.

The configuration and operation of the shop management server 400according to the present disclosure have been described above.

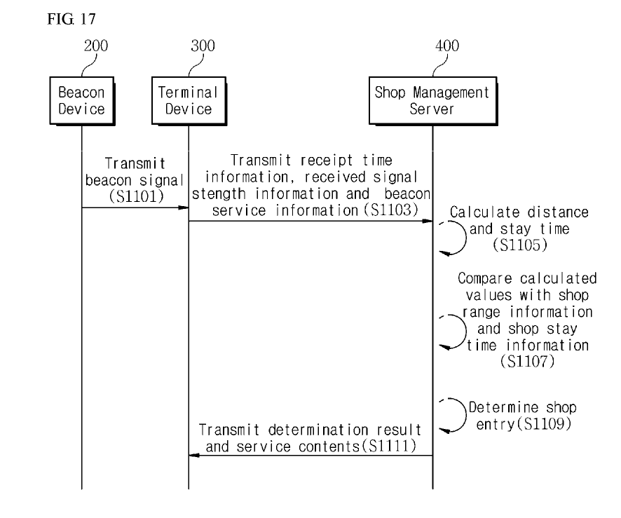

FIG. 16 is a flowchart illustrating a method of providing services utilizing the contents information providing system that uses priorities of the beacon devices according to the first implementation of the present disclosure.

The service providing method utilizing the contents information providing system that uses the priorities of the beacon devices shown in the drawing may include transferring shop-related information (S1001), determining a final shop list (S1003), requesting contents (S1005), and providing digital contents service (S1007).

In more detail, the service providing method may include an operation that the shop information providing device 500 provides the terminal device 300 with the unique information of the beacon device and the shop information stored in the shop information manager 520 (S1001), an operation that the terminal device 300 determines the final shop list by comparing priorities of the shops according to the unique information of the beacon device and shop information (S1003), an operation that the terminal device 300 requests the digital contents service associated with the final shop list to the shop management server 400 (S1005), and an operation that the shop management server 400 provides the digital contents service to the terminal device 300.

First, the shop information providing device 500 provides the terminal device 300 with the unique information of the beacon device and the shop information stored in the shop information manager 520 (S1001). The unique information of the sensor may be transferred by the beaconing technology as mentioned above. Meanwhile, the shop information stored in the shop information providing device 500 may be transferred through a separate communications channel to the terminal device 300.

Subsequently, the terminal device 300 may determine the final shop list by comparing priorities of the shops according to the unique information of the beacon device and shop information received from the shop information providing device 500 (S1003).

Afterwards, the terminal device 300 may request the digital contents service associated with the final shop list to the shop management server 400 (S1005),

Finally, the shop management server 400 may provide the terminal device 300 with the digital contents service requested by the terminal device 300.

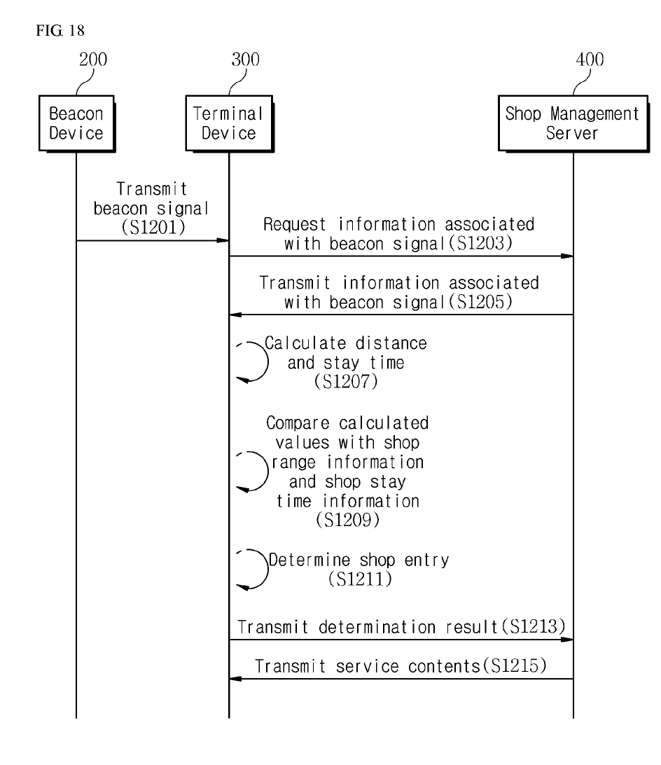

FIG. 17 shows a method of determining the shop entry/exit according to an implementation of the present disclosure. Referring to FIG. 17, when the beacon device 200 transmits the beacon signal (S1101), the terminal device 300 receives the beacon signal and transmits the beacon service information including the receipt time information, the signal strength information, the identification information included in the beacon signal to the shop management server 400 (S1103).

The shop management server 400 receiving the information may calculate the distance between the terminal device 300 and the beacon device 200 based on the received signal strength information and calculate the stay time based on the receipt time information (S1105). The shop management server 400 may compare the distance value with the preset shop range information, and compare the stay time value with the preset shop stay time information (S1107).

The shop management server 400 may determine that the terminal device 300 entered the shop if the calculated distance is smaller than the threshold for the shop range information, and the calculated stay time is greater than the threshold for the shop stay time information. Here, the shop management server 400 may preliminarily determine that the terminal device 300 enters the shop if the calculated distance value is smaller than the threshold for the shop range information, and finally determine that the terminal device 300 has entered the shop if the stay time value is greater than the threshold for the shop stay time information (S1109).

Afterwards, the shop management server 400 may transmit the service contents corresponding to the determination result and the stay time to the terminal device 300 (S1111). After finally determining that the terminal device 300 has entered the shop, the shop management server 400 may determine that the terminal device 300 exited the shop when the distance value is getting larger than the threshold for the shop range information.

FIG. 18 shows a method of determining the shop entry/exit according to another implementation.

When the beacon device 200 periodically transmits the beacon signal (S1201), the terminal device 300 receiving the beacon signal may request the shop management server 400 to provide the beacon signal related information including the shop range information and the shop stay time information of the shop corresponding to the received beacon signal, and receive the beacon signal related information (S1201, S1203).

If, however, the shop range information and the shop stay time information are already stored in the terminal device 300 the operations of S1201 and S1203 may be omitted.

The terminal device 300 may calculate the distance value between the terminal device 300 and the beacon device 200 based on the signal strength value of the received beacon signal and calculate the stay time value based on the receipt time value (S1205).

The terminal device 300 may compare the calculated distance value with the threshold for the shop range information, and compare the stay time value with the threshold for the shop stay time information (S1207). The terminal device 300 may determine that the terminal device 300 entered the shop if the calculated distance value is smaller than the threshold for the shop range information and the calculated stay time value is greater than the threshold for the shop stay time information (S1209).

Here, the terminal device 300 may preliminarily determine that the terminal device 300 enters the shop if the calculated distance value is smaller than the threshold for the shop range information, and finally determine that the terminal device 300 has entered the shop if the stay time value is greater than the threshold for the shop stay time information.

The terminal device 300 may transmit the determination result and the stay time value to the shop management server 400 (S1211), and the shop management server 400 may transmit the service contents corresponding to the stay time value to the terminal device 300 (S1213).

At this time, as the stay time is getting longer, the terminal device 300 may continue to transmit a updated stay time value to the shop management server 400, and the shop management server 400 may continue to transmit the service contents corresponding to the updated stay time value to the terminal device 300 (S1215).

Even after determining that the terminal device 300 entered the shop, the terminal device 300 may continue to calculate the distance value. The terminal device 300 may determine that the terminal device 300 exited the shop when the distance value is getting larger than the threshold for the shop range information.

The methods of determining the shop entry/exit according to implementations of the present disclosure have been described above.

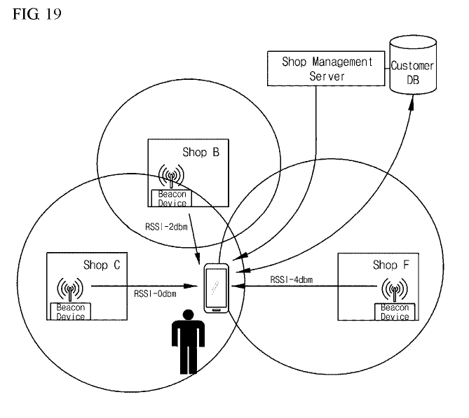

FIG. 19 shows a method of providing contents information service utilizing the contents information providing system that uses the beacon device propagation priority according to the first implementation of the present disclosure.

Hereinbelow, various examples of the first implementation of the present disclosure will be described with reference to FIG. 19.

In a method of providing contents information service using the beacon device propagation priority according to a first example of the first implementation of the present disclosure, only a single condition of the received signal strength is used. In this example, the proximity sensor 510 in each of the shop information providing devices 500 sends out the beacon signal. The terminal device 300 measures the signal strength of the received signal. Here, it is assumed that there are three shops, e.g. a first through third shops (SHOP A, SHOP B, SHOP C) and the received signal strengths of the signals from the first through third shops are 0 decibel-milliwatts (dBm), −4 dBm, and 4 dBm, respectively. The terminal device may sort the shop list in the order of descending received signal strength values. Thus, the shop list is sorted such that the third shop (SHOP C), the first shop (SHOP A), and the second shop (SHOP B) are listed in that order. The terminal device 300 transmits the sorted shop list to the shop management server 400, and the shop management server 400 transmits a coupon for the third shop (SHOP B) to the terminal device 300. Thus, the user may show the coupon and related digital contents to the corresponding shop to use the coupon in the shop.

In the method of providing contents information service according to a second example of the first implementation of the present disclosure, only a single condition of the administrator preference is used. In this example, basis information for determining the administrator preference set by the administrator (e.g., a service company providing a service platform) may include: the number of times that the terminal user has used the services on the platform, whether or not the user subscribed to the application associated with the provided service and the location information of the terminal user. The preference may be determined in three steps of ‘high’, ‘middle’, and ‘low’. For example, in case of the number of times of using the services, the preference is rated in ‘low’ when the service usage is greater than or equal to 10, in ‘middle’ when the service usage is greater than or equal to 20, and in ‘high’ when the service usage is greater than or equal to 30. Meanwhile, if the user is not a subscriber of the shop of which contents is to be provided to the terminal device, the determination of the preference is put off even when the number of service usage exceeds the predetermined criterion described above. In addition, when the location of the terminal user is farthest from the shop, the administrator preference may be lowered by one level. It is assumed that there are four users and all the users are stationary at respective positions.

It is further assumed that the number of service usages of the first through fourth users are 10, 20, 30, and 40, respectively, and the first through third users are subscribers of the shop of which contents is to be provided to the terminal device but the fourth user has not subscribed to the shop. The third user is farthest from the shop. There are two digital coupons that may be provided to the user.

The administrator preference for the first through third users may be rated in ‘low’, ‘middle’, and ‘high’, respectively, and the determination of the administrator preference for the fourth user may be put off. According to the administrator preference, the priorities of the users are determined in the order of: the third user, the second user, and the first user. Thus, the coupons are provided only to the second and third users by the shop management server 400.

In the method of providing contents information service according to a third example of the first implementation of the present disclosure, the condition of the customer purpose is used in determining the priorities. The customer purpose may be determined by the information of: preference of the terminal user for the good or the service, the price range of the good or the service, and the product type.

In this example, only the price range and the product type are considered for simplicity. The first user is interested in a cosmetic product, and is setting in mind the lowest price of 5,000 Korean Won (KW) and the highest price of 20,000 KW. The second user is interested in a cosmetic product, and is setting in mind the lowest price of 30,000 KW and the highest price of 50,000 KW. The third user is interested in a sports equipment, and is setting in mind the lowest price of 5,000 KW and the highest price of 100,000 KW. It is also assumed that there are three shops. The first shop is a sports goods shop and is selling products of which prices range from 5,000 KW. The second shop is cosmetics shop and is selling products of which prices range from 5,000 KW to 29,000 KR. The third shop is luxury cosmetics shop and is selling products of which prices range from 30,000 KW.

Under these conditions, for the first user, the first shop is not suitable because of the product type condition, and the third shop is not suitable because of the price range condition. However, the second shop can provide goods measuring up to the purpose of the first user. Thus, the terminal device 300 of the first user may request the shop management server 400 for a coupon of the second shop, and the shop management server 400 may transmit the coupon of the second shop to the terminal device 300 of the first user.

For the second user, the first shop is not suitable because of the product type condition, and the second shop is not suitable because of the price range condition. However, the third shop can provide goods measuring up to the purpose of the second user. Thus, the terminal device 300 of the second user may request the shop management server 400 for a coupon of the third shop, and the shop management server 400 may transmit the coupon of the third shop to the terminal device 300 of the second user.

For the third user, the second and third shops are not suitable because of the product type condition, but the first shop can provide goods measuring up to the purpose of the third user. Thus, the terminal device 300 of the third user may request the shop management server 400 for a coupon of the first shop, and the shop management server 400 may transmit the coupon of the first shop to the terminal device 300 of the third user.

In the method of providing contents information service according to a fourth example of the first implementation of the present disclosure, a plurality of conditions of the received signal strength, the administrator preference, and the customer purpose may used in determining the priorities.

Under an assumption that all the users are stationary at respective positions, the shops may be sorted in an order of: the first shop (−10 dBm), the second shop (−5 dBm), the third shop (0 dBm), and the fourth shop (5 dBm) in terms of the received signal strength. It is also assumed that the first and third shops are selling cosmetic products and the second and fourth shops are selling sports goods products. The platform service providing company is going to provide the digital coupons of four coupons to four users of higher priorities according to the administrator preference among a total five users. The first and second users wishes to purchase cosmetic products, and the third through fifth users wishes to purchase sports equipment. All users have no price limit on purchasing goods.

The terminal device 300 determines the final shop list after determining the priorities of the shops taking all the three conditions into account. In the final shop list in the terminal device 300 of the first and second users, the shops are sorted in the order of: the first shop and the third shop. In the shop list in the terminal device 300 of the third and fourth users, the shops are sorted in the order of: the second shop and the fourth shop. The terminal device 300 of the fifth user does not satisfy the condition of the administrator preference and cannot receive digital contents from the administrator, and thus the final shop list is not provided to the fifth terminal device.

If the user deselects the administrator preference, the final shop list containing the shops arranged in the order of the second shop and the fourth shop may be provided to the fifth terminal device. Nevertheless, however, the digital contents such as the coupon may not be provided to the terminal device 300 of the fifth user because of the administrator preference.

Meanwhile, in case that a higher weighting factor is applied to the customer purpose condition and the first shop has more favorable condition than the third shop in terms of the customer purpose condition, the final shop list containing the first shop and the third shop in that order may be reorganized, so that the third shop and the first shop are listed in that order.

In the method of providing contents information service according to a fifth example of the first implementation of the present disclosure, an indoor/outdoor map may be constructed by using the condition of the received signal strength. The measurement of the distance is based on a principle that the signal strength is generally inversely proportional to the square of the distance.

When the beacon devices in the first through the third shops transmit the beacon signals of the same intensity, the received signal strengths at the terminal device 300 of the first user may be different from one another because of the differences in the distances between the terminal device 300 and the respective beacon devices. Thus, if the received signal strengths for the signals transmitted from three or more access points (APs) installed at three shops are measured at the terminal device 300 and the distances between the terminal device 300 and the respective APs are calculated, the locations of the APs may be calculated and a map indicating the locations of the shops may be constructed. The accuracy of the map may be enhanced if the received signal strengths measured at the terminal device 300 of the second user are additionally utilized in the calculation of the location. It is possible to construct an accurate map containing the locations of the indoor/outdoor shops if the received signal strengths measured at the terminal devices 300 of the first and second users or more users are utilized.

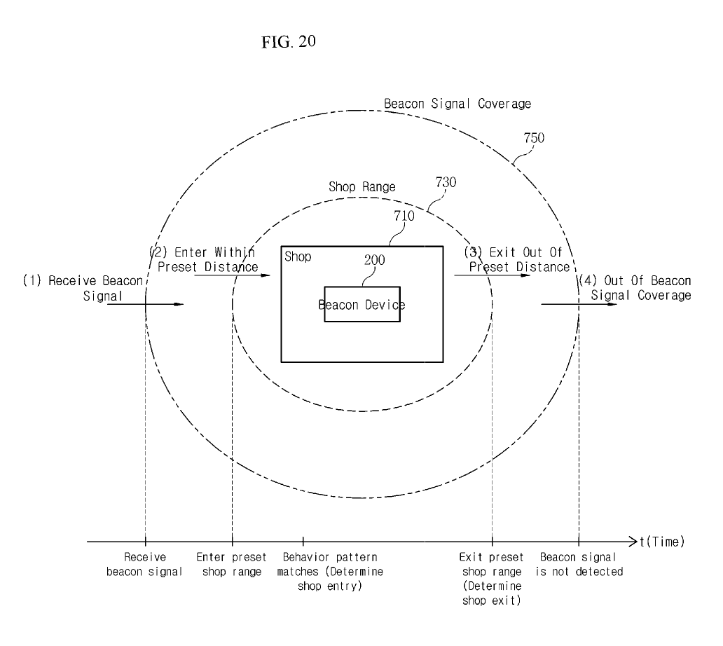

The overall process of determining the shop entry/exit according to a second and third implementations will now described with reference to FIG. 20. The beacon device 200 is installed at a shop. Although the beacon device 200 is installed generally at the center or at the entrance of the shop, the installation position is not limited thereto and the beacon device 200 may be installed at any place of the shop. There is no limit in the number of the beacon device 200 that may be installed in a shop, and a plurality of the beacon devices 200 may be installed in a shop.

A reference numeral 710 denotes an actual area of a shop, a reference numeral 730 corresponds to the threshold of the shop range that is set in the shop range information, and a reference numeral 750 denotes a beacon signal coverage that the beacon signal may reach substantially.

As shown in FIG. 20, the threshold of the shop range 530 does not necessarily coincide with the beacon signal coverage 550, and may be set arbitrarily to facilitate an accurate determination of the shop entry/exit. However, the threshold of the shop range 530 set in the shop range information should be smaller than or identical to the beacon signal coverage 550.

The method of determining the shop entry/exit according to the second implementation of the present disclosure may be performed as follows. If the terminal device 300 enters the beacon signal coverage 550 and receives the beacon signal, the terminal device 300 calculates the distance between the terminal device 300 and the beacon device 200 based on the received signal strength. The calculating operation may be executed whenever the beacon signal is received by the terminal device 300. If the calculated distance falls below the preset threshold of the shop range, the terminal device 300 may be preliminarily determined to have entered the shop.

After the terminal device 300 is preliminarily determined to have entered the shop, the stay time is calculated based on the receipt time of the beacon signal that is received after the terminal device 300 have entered the shop. If the calculated stay time exceeds the threshold for the stay time, the terminal device 300 may be finally determined to have entered the shop.

The terminal device 300 may be determined to have exited the shop if the calculated distance becomes larger than the threshold for the shop range information after the terminal device 300 is finally determined to have entered the shop. If the terminal device 300 gets out of the beacon signal coverage 550, the terminal device 300 cannot detect the beacon signal.

The method of determining the shop entry/exit according to the third implementation may be performed as follows. If the terminal device 300 enters the beacon signal coverage 550 and receives the beacon signal, the terminal device 300 calculates the distance between the terminal device 300 and the beacon device 200 based on the received signal strength. The calculating operation may be executed whenever the beacon signal is received by the terminal device 300. If the calculated distance falls below the preset threshold of the shop range, the terminal device 300 may be preliminarily determined to have entered the shop.

After the terminal device 300 is preliminarily determined to have entered the shop, the current situation of the user is recognized based on the sensing information collected by one or more sensors mounted in the terminal device 300 and the behavior pattern of the user is extracted based on the recognized situation of the user. If the extracted behavior pattern matches the behavior pattern information, the terminal device 300 may be finally determined to have entered the shop.

Also, the stay time may be utilized additionally to enhance the accuracy of the determination of the shop entry/exit. After it is checked that the extracted behavior pattern matches the behavior pattern information, the stay time may be calculated based on the receipt time of the beacon signal. If the calculated stay time exceeds the threshold for the stay time, the terminal device 300 may be finally determined to have entered the shop.

The terminal device 300 may be determined to have exited the shop if the calculated distance becomes larger than the threshold for the shop range information after the terminal device 300 is finally determined to have entered the shop. If the terminal device 300 gets out of the beacon signal coverage 550, the terminal device 300 cannot detect the beacon signal.

The method of determining the shop enter/exit according to implementations of the present disclosure have been described above.

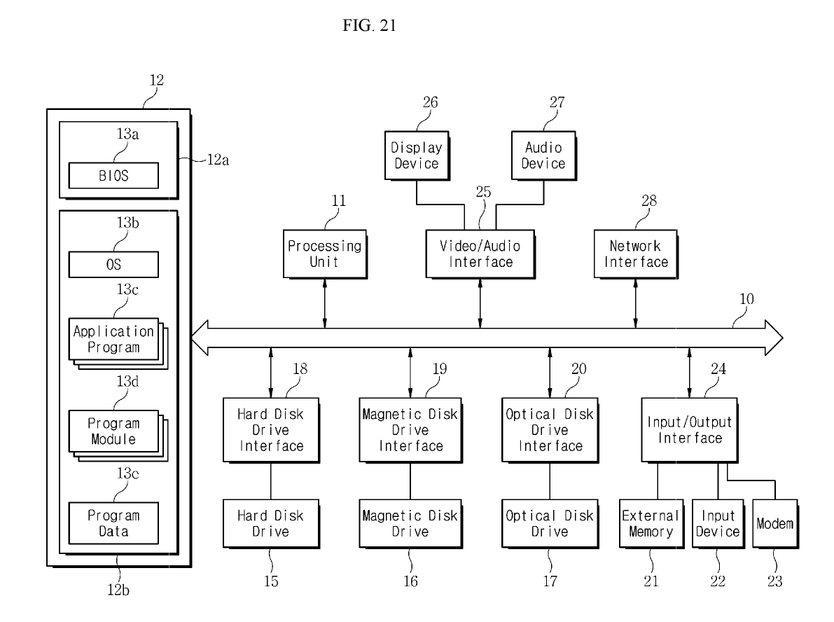

FIG. 21 is a block diagram illustrating an operation environment of a system for determining shop entry/exit according to an implementation of the present disclosure.

FIG. 21 and the following description are intended to provide a brief and general description of a suitable computing environment in which the present disclosure may be implemented. Although it is not required, the present disclosure may be described in connection with computer-executable instructions such as program modules that may be executed by a computer system. Generally, the program modules include routines, programs, objects, components, data structures, and so on suitable for performing particular tasks or implementing particular abstract data types. The computer-executable instructions, associated data structures, and program modules exemplify the program code means for carrying out processes described herein.

Referring to FIG. 21, an exemplary computing system suitable for implementing the present disclosure may include a processing unit 11, a system memory 12, and a system bus 10 that connects various system components including the system memory 12 to the processing unit 11.

The processing unit 11 is capable of executing computer-executable instructions designed to implement the features of the present disclosure.

The system bus 10 may be any of several types of bus architectures including a local bus, an external bus, and a memory bus. Alternatively, the system bus 10 may be any of the bus architectures employing a memory controller. The system memory 12 includes a read-only memory (ROM) 12A and a random access memory 12B. A Basic Input/Output System (BIOS) 13A which includes basic routines that help information transfer between components within the computing system when the system is booted may generally be stored in the ROM 12A.

The computing system may include storage devices. For example, the computing system may include a hard disk drive 15 that reads information from or writes information to a hard disk, a magnetic disk drive 16 that reads information from or writes information to a magnetic disk, and an optical disk drive 17 that reads information from or writes information to an optical disk such as a CD-ROM and other optical medium. The hard disk drive 15, the magnetic disk drive 16, and the optical disk drive 17 may be connected to the system bus 10 by a hard disk drive interface 18, a magnetic disk drive interface 19, and an optical drive interface 20, respectively.

Also, the computing system may further include an external memory 21 as one kind of the storage device. The external memory 21 may be connected to the system bus 10 through an input/output (I/O) interface 24.

The above-described drives and the computer-readable media that may be accessed by the drives allows nonvolatile storage of computer-executable instructions, data structures, program modules, and other data. The exemplary environment described herein illustrates the hard disk 15, the magnetic disk 16, and the optical disk 17, but other types of computer-readable media for storing data such as a magnetic cassette, a flash memory card, a DVD, a Bernoulli cartridge, a RAM, and a ROM may be used as well.

The program code means including one or more program modules that may be loaded and executed by the processing unit 11 and includes an operating system 13B, one or more application programs 13C, other program modules 13D, and program data 13E may be stored in the hard disk 15, the magnetic disk 16, the optical disk 17, the ROM 12A or the RAM 12B.

Also, the computing system may receive commands and information from a user through input devices 22 such as a keyboard, a pointing device, a microphone, a joystick, a game pad, and a scanner. These input devices 22 may be connected to the processing unit 11 via the I/O interface 24 connected to the system bus 10. The I/O interface 24 may logically represent at least one or a combinations of various interfaces such as, for example, a serial port interface, a PS/2 interface, a parallel port interface, a USB interface, an Institute of Electrical and Electronics Engineers (IEEE) 1394 interface (i.e., FireWire interface), and other interfaces.

In addition, the computing system may further include a display device 26 such as a monitor and a liquid crystal display (LCD), and an audio device 27 such as a speaker and a microphone. The display device 26 and the audio device 27 may be connected to the system bus 10 through a video/audio interface 25. Other peripheral devices (not shown) such as a speaker and a printer, for example, may be connected to the computing system. The video/audio interface 25 may include a High Definition Multimedia Interface (HDMI) and Graphics Device Interface (GDI).

The computing system may be connected to a network such as, for example, an office wide area network (WAN) or an enterprise WAN, a home network, Intranet, and/or Internet. The computing system may exchange data with external sources such as, for example, a remote computer system, a remote application, and/or a remote database.

To this end, the computing system may include a network interface 28 for receiving data from an external source and/or transmitting data to the external source.

The computing system may transmit and receive information to and from a remote device through the network interface 28. For example, in case that the computing system refers to the terminal device 300, the computing system may communicate with the beacon device 200 and the shop management server 400 through the network interface 28. On the other hand, in case that the computing system refers to the beacon device 200 or the shop management server 400, the computing system may exchanged information with the terminal device 300 through the network interface 28. The network interface 28 may represent a network interface card, or an equivalent software such as a network driver interface specification (NDIS) stack, an equivalent hardware, and/or a logical combination of the software and hardware.

Likewise, the computing system may transmit and receive data to and from an external source through the I/O interface 24. The I/O interface 24 may be connected to a modem 23 such as a standard modem, a cable modem, and a digital subscriber line (DSL) modem. The computing system may transmit and receive data to and from the external source through the modem 23.

Although FIG. 21 shows an operating environment suitable for the present disclosure, the principles of the present disclosure may be applicable to any other system capable of implementing the principles of the present disclosure with an appropriate modifications, if necessary. The environment shown in FIG. 21 is illustrative only and does not represent even a small portion of various environments in which the principles of the present disclosure may be implemented.

In addition, various information generated during the determination of the shop entry/exit can be stored and accessed in a computer-readable medium related with the computing system. For example, a portion of these program modules and a portion of the associated program data may be included in the operating system 13B, the application program 13C, the program module 13D, and/or the program data 13E to be stored in the system memory 12.

Further, when a mass storage device such as the hard disk is connected to the computing system, such program module and related program data may be stored in the mass storage device. In a networked environment, the program modules associated with the present disclosure, or portions thereof, may be stored in a remote computer system connected via the I/O interface 24 and the modem 23 or the network interface 25. The execution of such a module may be performed in a distributed environment as described above.

While the present specification contains a number of specific implementation details, it should be understood that they are not to be construed as limitations on the scope of any disclosure or claims, but as a description of features that may be specific to a particular implementation of a particular disclosure. Certain features described with respect to contexts of independent implementations may be implemented in combination in a single implementation. Conversely, various features described in the context of a single implementation may also be implemented in other implementations either individually or in any suitable sub-combination. Further, although some features may be described to operate in a particular combination and may be initially depicted as so claimed, one or more features from the claimed combination may in some cases be excluded from the combination, and a claimed combination may be replaced by a sub-combination or a variant of the sub-combination.

Similarly, although the operations are depicted in the drawings in a particular order, it should not be understood that such operations need to be performed in that particular order or sequential order shown to achieve the desired result or all the depicted operations should be performed. In certain cases, multitasking and parallel processing may be advantageous. Also, The fragmentation of the various system components in the above-described implementations should not be understood as requiring such fragmentation in all implementations, and the program components and systems described above may generally be integrated together into a single software product or packaged into a multiple-function software product.

Although specific implementations of the subject matter have been described herein, other implementations are within the scope of the following claims. For example, the operations defined in the claims may be performed in a different order to still achieve desirable results. By way of example, the process illustrated in the accompanied drawings does not necessarily require that particularly illustrated sequence or sequential order to achieve the desired result. In certain implementations, multitasking and parallel processing may be advantageous.

The descriptions set forth above disclose the best mode of the present disclosure, and is provided to illustrate the disclosure and to enable those skilled in the art to make and use the disclosure. The written description is not intended to limit the disclosure to the specific terminology presented. Thus, although the present disclosure has been described in detail with reference to the above examples, those skilled in the art will be able to make adaptations, modifications, and variations on the examples without departing from the scope of the present disclosure.

Accordingly, the scope of the present disclosure should not be limited by the illustrated implementations but should be defined by the appended claims.

The present disclosure relates to a method of providing contents providing service and a method of determining entry or exit in a shop by utilizing beacon. More particularly, the present disclosure relates to a method and system for providing digital contents such as a digital coupon to a terminal device of a user by use of strength of and information in radio waves transmitted by a beacon device and determining the entry/exit of the terminal device in the shop by utilizing behavior pattern of the user holding the terminal device.

According to the present disclosure, sensor information received from a plurality of beacon devices installed in respective one of a plurality of shops or a shop complex not being compartmentalized may be processed effectively by utilizing the received signal strength information, and a possibility that the digital contents are treated as spam may be reduced.

Also, since one of the shops is selected in consideration of the administrator preference and the customer's purpose of using the product in addition to the received signal strength, and services associated with a selected shop is provided to the terminal device, contents customized to the administrator or the customer may be provided to the user.

When the terminal device receives the beacon signal from the beacon device, the distance from the beacon device transmitting the beacon signal is estimated based on the received signal strength, the stay time is calculated based on the signal receipt time, the user's situation is recognized based on sensing information measured by one or more sensors, the behavior pattern of the user is extracted based on the recognized situation, and then the shop entry/exit is determined based on the estimated distance, the calculated stay time, and the extracted behavior pattern. Accordingly, the entry/exit of the terminal device at a shop may be determined accurately.

When the calculated stay time of a customer is long at a shop, the customer is expected to have high purchase intension at the shop, and service contents corresponding to the stay time is provided to the terminal device of the customer. Thus, the shop may enhance a buying rate of the customer at the shop, and the customer may achieve reasonable consumption.

Thus, the present disclosure may contribute to the development of the beacon service industry through the method of providing contents providing service and the method of determining shop entry/exit. The present disclosure is industrially applicable because it can actually be implemented obviously and has a sufficiently high possibility of commercialization or sales.

What is claimed is:

1. A terminal device, comprising:
a receiving unit configured to receive beacon device unique information and shop information from shop information providing devices installed in respective one of at least one shops;
a managing unit configured to manage a list of shops according to the beacon device unique information and the shop information;
a processing unit configured to determine a final shop list including candidate shops that have been given high priorities by the managing unit by taking into account the shop information; and
a transmission unit configured to request a shop management server for a digital content service related to the final shop list.

2. The terminal device of claim 1, further comprising:
a priority determination module configured to sort the list of shops according to the priorities of the shops.

3. The terminal device of claim 2, wherein the priority determination module comprises:
a signal strength measurement unit configured to measure signal strength of a received signal transmitted by the shop information providing devices;
an administrator preference determination unit configured to determine preference of an administrator providing the digital content service;
a customer purpose determination unit configured to determine a purpose of using a good or a service of a user of the terminal device receiving the digital contents service; and
a sorting unit configured to sort the list of shops based on priority comparison basis information provided by the signal strength measurement unit, the administrator preference determination unit, and the customer purpose determination unit.

4. The terminal device of claim 3, wherein the administrator preference determination unit determines the administrator preference based on at least one information of: a number of times that the user has used the digital content service provided by the administrator, whether or not the user agreed to provide location information, a location of the terminal device identified by provided location information, an age or sex of the user, and whether or not the user subscribed to an application associated with the digital content service.

5. The terminal device of claim 3, wherein the customer purpose determination unit determines the purpose of the user by using at least one of: preference of the user for the good or the service, a price range of the good or the service, and a product type.

6. The terminal device of claim 3, wherein the sorting unit sorts the list of shops after applying weighting factors to each of the priority comparison basis information.

7. The terminal device of claim 3, wherein the sorting unit chooses at least one kind of basis information among the priority comparison basis information provided by the signal strength measurement unit, the administrator preference determination unit, and the customer purpose determination unit, and sorts the list of shops based on chosen basis information only.

8. The terminal device of claim 2, wherein the shop information of the candidate shops having been given the high priorities by the managing unit includes at least one of: a business type of the shop, a size of the shop, a number of products in the shop, a number of employees, a number of daily visiting customers, and a number of customers currently in the shop,
wherein the processing unit determines the candidate shops to be included in the final shop list based on the shop information as well as information whether the user is staying in the shop or has moved to another shop.

9. A method of providing contents information service using beacon device priority by a terminal device, comprising:
(a) receiving beacon device unique information and shop information from shop information providing devices installed in respective one of at least one shops;
(b) managing a list of shops according to the beacon device unique information and the shop information;
(c) determining a final shop list including candidate shops that have been given high priorities by the managing unit by taking into account the shop information; and
(d) requesting a shop management server for a digital content service related to the final shop list.

10. A terminal device, comprising:
a first communication module configured to receive a beacon signal periodically transmitted by a beacon device; and
a control module configured to calculate a distance to the beacon device based on a received signal strength of the beacon signal, and determines that the terminal device entered a shop in which the beacon device is installed when a calculated distance is smaller than a threshold for shop range information corresponding to the shop.

11. The terminal device of claim 10, wherein the control module further calculates a stay time based on a receipt time of the beacon signal, and determines that the terminal device entered the shop when a calculated stay time is greater than a threshold for shop stay time information corresponding to the shop.

12. The terminal device of claim 11, wherein the control module preliminarily determines that the terminal device entered the shop if the calculated distance is smaller than the threshold for the shop range information, and finally determines that the terminal device entered the shop if the calculated stay time is greater than the threshold for the shop stay time information.

13. The terminal device of claim 12, wherein the control module determines that the terminal device exited the shop when the calculated distance acquired after the terminal device is determined to have entered the shop is getting larger than the threshold for the shop range information corresponding to the shop.

14. The terminal device of claim 12, wherein the control module controls the terminal device to receive a service content of the shop corresponding to the calculated stay time from a shop management server and to expose the service content through an output module when the terminal device is determined to have entered the shop.

15. The terminal device of claim 11, further comprising:
a second communication module configured to transmit and receive data to and from a shop management server through a communications network,
wherein the control module receives the shop range information and the shop stay time information through the second communication module.

16. The terminal device of claim 10, further comprising:
a sensor module including at least one sensor configured to output sensing information representing a physical change in the vicinity of the terminal device,
wherein the control module recognizes user's situation based on the sensing information, extract behavior pattern of the user based on recognized situation information, and determines that the terminal device entered the shop when extracted behavior pattern matches preset behavior pattern information.

17. The terminal device of claim 16, wherein the control module preliminarily determines that the terminal device entered the shop if the calculated distance is smaller than the threshold for the shop range information, and finally determines that the terminal device entered the shop if the extracted behavior pattern matches the preset behavior pattern information.

18. The terminal device of claim 17, wherein the control module calculates a stay time based on a receipt time of the beacon signal when the extracted behavior pattern matches the preset behavior pattern information, and finally determines that the terminal device entered the shop when the calculated stay time is greater than the threshold for the shop stay time information.

19. The terminal device of claim 16, wherein the behavior pattern information is set separately for each shop in which the beacon device is installed based on information of the shop.

20. The terminal device of claim 16, further comprising:
a second communication module configured to transmit and receive data to and from a shop management server through a communications network,
wherein the control module receives the shop range information and the behavior pattern information through the second communication module.

21. A shop management server, comprising:
a communication module configured to transmit and receive data to and from a terminal device through a communications network;
a storage module configured to store shop range information of a shop corresponding to a beacon device; and
a control module configured to calculate a distance between the terminal device and the beacon device based on a received signal strength of a beacon signal when the received signal strength is received from the terminal device that have received the beacon signal through the communication module, and determines that the terminal device entered the shop when a calculated distance is smaller than a threshold for the shop range information.

22. The shop management server of claim 21, wherein the storage module further stores stay time information of the shop corresponding to the beacon device,
wherein the control module further calculates a stay time based on a receipt time of the beacon signal when receipt time of the beacon signal is received from the terminal device that have received the beacon signal through the communication module, and determines that the terminal device entered the shop when a calculated stay time is greater than a threshold for the stay time information.

23. The shop management server of claim 22, wherein the control module preliminarily determines that the terminal device entered the shop if the calculated distance is smaller than the threshold for the shop range information, and finally determines that the terminal device entered the shop if the calculated stay time is greater than the threshold for the shop stay time information.

24. The shop management server of claim 23, wherein the control module determines that the terminal device exited the shop when the calculated distance acquired after the terminal device is determined to have entered the shop is getting larger than the threshold for the shop range information corresponding to the shop.

25. The shop management server of claim 23, wherein the control module controls the shop management server to transmit a service content of the shop corresponding to the calculated stay time to the terminal device when the terminal device is determined to have entered the shop.

26. The shop management server of claim 21, wherein the storage module further stores behavior pattern information of the shop corresponding to the beacon device,
wherein the control module extracts a behavior pattern based on at least one sensing information collected by the terminal device, and determines that the terminal device entered the shop when the extracted behavior pattern matches the behavior pattern information stored in the storage unit.

27. The shop management server of claim 26, wherein the control module preliminarily determines that the terminal device entered the shop if the calculated distance is smaller than the threshold for the shop range information, and finally determines that the terminal device entered the shop if the extracted behavior pattern matches the behavior pattern information stored in the storage unit.

28. The shop management server of claim 26, wherein the behavior pattern information is set separately for each shop in which the beacon device is installed based on information of the shop.

29. A method of determining shop entry/exit based on a beacon signal transmitted from a beacon device installed in a shop, comprising:
checking a received signal strength of the beacon signal received by a terminal device located closely to the shop;
calculating a distance between the beacon device and the terminal device based on the received signal strength;
comparing a calculated distance with a threshold for shop range information; and
determining the terminal device entered the shop if the calculated distance is smaller than the threshold for the shop range information.

30. The method of claim 29, wherein, in the checking operation, a receipt time of the beacon signal is further checked,
wherein, in the calculating operation, a stay time is further calculated based on the receipt time,
wherein, in the comparing operation, the calculated stay time is compared with a threshold for shop stay time information,
wherein, in the determining operation, the terminal device is determined to have entered the shop if the stay time is greater than the threshold for the shop stay time information.

31. The method of claim 29, further comprising:
extracting behavior pattern based on at least one sensing information collected by the terminal device,
wherein, in the comparing operation, an extracted behavior pattern is compared with preset behavior pattern information,
wherein, in the determining operation, the terminal device is determined to have entered the shop if the extracted behavior pattern matches the preset behavior pattern information.
